(19) United States
(12) Patent Application Publication
(10) Pub. No.: US 2026/0333424 A1
(43) Pub. Date: Oct. 22, 2026

(54) ELIGIBILITY FOR SIDELINK COMMUNICATIONS DURING SHARED CHANNEL OCCUPANCY TIME

(71) Applicant: QUALCOMM Incorporated, San Diego, CA (US)

(72) Inventors: Siyi CHEN, Beijing (CN); Jing SUN, San Diego, CA (US); Xiaoxia ZHANG, San Diego, CA (US); Chih-Hao LIU, San Diego, CA (US); Changlong XU, Beijing (CN); Shaozhen GUO, Beijing (CN); Luanxia YANG, Beijing (CN); Hao XU, Beijing (CN)

(21) Appl. No.: 19/101,294

(22) PCT Filed: Sep. 23, 2022
(86) PCT No.: PCT/CN2022/120741

§ 371 Date: Feb. 5, 2025

(51) Int. Cl. H04W 74/0808; H04W 92/18

(52) U.S. Cl. CPC H04W 74/0808; H04W 92/18

(57) ABSTRACT

Wireless communications systems, apparatuses, and methods are provided. According to one aspect, a method of wireless communication performed by a first user equipment (UE) includes: receiving, from a second UE, an indication of a channel occupancy time (COT) associated with the second UE; and transmitting, to a third UE in a shared portion of the COT, a sidelink (SL) communication. In some aspects, the transmitting the SL communication is based on at least one of: a distance between the second UE and the third UE; or a channel condition between the second UE and the third UE.

### TECHNICAL FIELD

This application relates to wireless communication systems, and more particularly, to channel occupancy time sharing for sidelink communications.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the LTE technology to a next generation new radio (NR) technology. For example, NR is designed to provide a lower latency, a higher bandwidth or throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

NR may support various deployment scenarios to benefit from the various spectrums in different frequency ranges, licensed and/or unlicensed, and/or coexistence of the LTE and NR technologies. For example, NR can be deployed in a standalone NR mode over a licensed and/or an unlicensed band or in a dual connectivity mode with various combinations of NR and LTE over licensed and/or unlicensed bands.

In a wireless communication network, a BS may communicate with a UE in an uplink direction and a downlink direction. Sidelink was introduced in LTE to allow a UE to send data to another UE (e.g., from one vehicle to another vehicle) without tunneling through the BS and/or an associated core network. The LTE sidelink technology has been extended to provision for device-to-device (D2D) communications, vehicle-to-everything (V2X) communications, and/or cellular vehicle-to-everything (C-V2X) communications. Similarly, NR may be extended to support sidelink communications, D2D communications, V2X communications, and/or C-V2X over licensed frequency bands and/or unlicensed frequency bands (e.g., shared frequency bands).

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

According to an aspect of the present disclosure, a method for SL communications in an unlicensed frequency band may include or involve a UE transmitting, during a shared portion of a COT, a SL communication to a non-COT initiating UE based on at least one of a distance between the COT-initiating UE and the receiving UE, or a channel condition between the COT-initiating UE and the receiving UE. For example, if the UE sharing the COT determines that the distance between the COT-initiating UE and the receiving UE exceeds a configured distance threshold, the UE sharing the COT may refrain from transmitting to the receiving UE during the shared portion of the COT. In this regard, the relatively large distance may decrease the reliability of the COT-initiating UE's or the COT-sharing UE's clear channel assessment in estimating or predicting the interference experienced by the receiving UE. Similarly, poor channel conditions (e.g., high pathloss, low received signal power) between the COT-initiating UE and the receiving UE may also reduce the confidence of the clear channel assessments in predicting the interference experienced by the receiving UE.

According to another aspect of the present disclosure, a method of wireless communication performed by a first user equipment (UE) comprises: receiving, from a second UE, an indication of a channel occupancy time (COT) associated with the second UE; and transmitting, to a third UE in a shared portion of the COT, a sidelink (SL) communication, wherein the transmitting the SL communication is based on at least one of: a distance between the second UE and the third UE; or a channel condition between the second UE and the third UE.

According to another aspect of the present disclosure, a method of wireless communication performed by a first user equipment (UE) comprises: transmitting, to a second UE, an indication of a channel occupancy time (COT) initiated by the first UE; and transmitting, to the second UE, a list of one or more UEs eligible for receiving sidelink (SL) communications from the second UE in a shared portion of the COT, wherein the one or more UEs are different from the first UE and the second UE, and wherein the list is based on at least one of: a distance between the first UE and each of the one or more UEs; or a channel condition between the first UE and each of the one or more UEs.

According to another aspect of the present disclosure, a first user equipment (UE) comprises: a memory device; a transceiver; and a processor in communication with the memory device and the transceiver, wherein the UE is configured to: receive, from a second UE, an indication of a channel occupancy time (COT) associated with the second UE; and transmit, to a third UE in a shared portion of the COT, a sidelink (SL) communication, wherein the transmitting the SL communication is based on at least one of: a distance between the second UE and the third UE; or a channel condition between the second UE and the third UE.

According to another aspect of the present disclosure, a first user equipment (UE) comprises: a memory device; a transceiver; and a processor in communication with the memory device and the transceiver, wherein the UE is configured to: transmit, to a second UE, an indication of a channel occupancy time (COT) initiated by the first UE; and transmit, to the second UE, a list of one or more UEs eligible for receiving sidelink (SL) communications from the second UE in a shared portion of the COT, wherein the one or more UEs are different from the first UE and the second UE, and wherein the list is based on at least one of: a distance between the first UE and each of the one or more UEs; or a channel condition between the first UE and each of the one or more UEs.

Other aspects, features, and instances of the present invention will become apparent to those of ordinary skill in the art, upon reviewing the following description of specific, exemplary instances of the present invention in conjunction with the accompanying figures. While features of the present invention may be discussed relative to certain aspects and figures below, all instances of the present invention can include one or more of the advantageous features discussed herein. In other words, while one or more instances may be discussed as having certain advantageous features, one or more of such features may also be used in accordance with the various instances of the invention discussed herein. In similar fashion, while exemplary aspects may be discussed below as device, system, or method instances it should be understood that such exemplary instances can be implemented in various devices, systems, and methods.

### BRIEF DESCRIPTION OF THE DRAWINGS

FIG. 1 illustrates a wireless communication network according to some aspects of the present disclosure.

FIG. 2 illustrates an example of a wireless communication network that provisions for sidelink communications according to aspects of the present disclosure.

FIG. 3 illustrates an example of COT sharing resources according to some aspects of the present disclosure.

FIG. 4 illustrates an example of frequency division multiplexing of COT sharing resources according to some aspects of the present disclosure.

FIG. 5 illustrates an example of time division multiplexing of COT sharing resources according to some aspects of the present disclosure.

FIG. 6 is a signaling diagram of a wireless communication method according to some aspects of the present disclosure.

FIG. 7 is a block diagram of an exemplary user equipment (UE) according to some aspects of the present disclosure.

FIG. 8 is a block diagram of an exemplary network unit according to some aspects of the present disclosure.

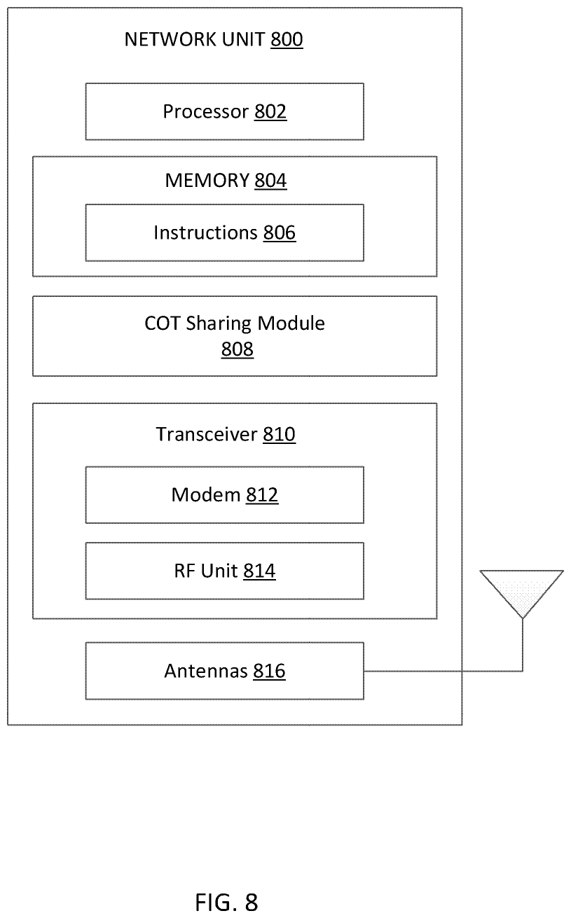

FIG. 9 is a flow diagram of a communication method according to some aspects of the present disclosure.

FIG. 10 is a flow diagram of a communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various instances, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronic Engineers (IEEE) 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ~1 M nodes/km²), ultra-low complexity (e.g., ~10 s of bits/sec), ultra-low energy (e.g., ~10+ years of battery life), and deep coverage with the capability to reach challenging locations; (2) including mission-critical control with strong security to safeguard sensitive personal, financial, or classified information, ultra-high reliability (e.g., ~99.99999% reliability), ultra-low latency (e.g., ~1 ms), and users with wide ranges of mobility or lack thereof, and (3) with enhanced mobile broadband including extreme high capacity (e.g., ~10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

The deployment of NR over an unlicensed spectrum is referred to as NR-unlicensed (NR-U). Federal Communications Commission (FCC) and European Telecommunications Standards Institute (ETSI) are working on regulating 6 GHz as a new unlicensed band for wireless communications. The addition of 6 GHz bands allows for hundreds of megahertz (MHz) of bandwidth (BW) available for unlicensed band communications. Additionally, NR-U can also be deployed over 2.4 GHz unlicensed bands, which are currently shared by various radio access technologies (RATs), such as IEEE 802.11 wireless local area network (WLAN) or WiFi and/or license assisted access (LAA). Sidelink communications may benefit from utilizing the additional bandwidth available in an unlicensed spectrum. However, channel access in a certain unlicensed spectrum may be regulated by authorities. For instance, some unlicensed bands may impose restrictions on the power spectral density (PSD) and/or minimum occupied channel bandwidth (OCB) for transmissions in the unlicensed bands. For example, the unlicensed national information infrastructure (UNII) radio band has a minimum OCB requirement of about at least 70 percent (%).

Some sidelink systems may operate over a 20 MHz bandwidth, e.g., for listen before talk (LBT) based channel accessing, in an unlicensed band. A BS may configure a sidelink resource pool over one or multiple 20 MHz LBT sub-bands for sidelink communications. A sidelink resource pool is typically allocated with multiple frequency subchannels within a sidelink band width part (SL-BWP) and a sidelink UE may select a sidelink resource (e.g., one or multiple subchannels in frequency and one or multiple slots in time) from the sidelink resource pool for sidelink communication.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In some aspects, one or more UEs in a network may communicate with one another using unlicensed or shared frequency bands. Because of the nature of unlicensed frequency bands or channels, the UEs may perform channel access procedures to assess the interference on one or more frequency bands before making a transmission. If the total interference detected during a configured sensing window is below a threshold, a UE may acquire a time window, which may be a channel occupancy time (COT) during which the UE can communicate with one or more other UEs. In some aspects, a UE may desire to share at least a portion of the COT with one or more other UEs. For example, the UE that performed the channel access procedure and acquired or initiated the COT may share a portion of the COT with a second UE so that the second UE may communicate back to the COT-initiating UE. The UE sharing the COT may perform an additional channel access procedure before communicating in the shared portion of the COT. In some scenarios, it may be desirable to allow the UE sharing the COT to transmit to one or more UEs other than the COT-initiating UE. For example, a first UE may initiate a COT and share a portion of the COT with a second UE. The second UE may have an SL communication scheduled for a third UE. For example, the second UE may have SL feedback information to communicate to the third UE during the shared portion of the COT. Although the second UE may also perform a channel access procedure before communicating in the shared portion of the COT, neither the first channel access procedure performed by the first UE nor the second channel access procedure performed by the second UE may adequately represent the interference or channel conditions experienced by the third UE that would receive the SL communication from the second UE. For example, the distance between the first UE and the third UE may be significantly large, or the environment may create a large pathloss for communications to the third UE.

According to an aspect of the present disclosure, a method for SL communications in an unlicensed frequency band may include or involve a UE transmitting, during a shared portion of a COT, a SL communication to a non-COT-initiating UE based on at least one of a distance between the COT-initiating UE and the receiving UE, or a channel condition between the COT-initiating UE and the receiving UE. For example, if the UE sharing the COT determines that the distance between the COT-initiating UE and the receiving UE exceeds a configured distance threshold, the UE sharing the COT may refrain from transmitting to the receiving UE during the shared portion of the COT. In this regard, the relatively large distance may decrease the reliability of the COT-initiating UE's or the COT-sharing UE's clear channel assessment in estimating or predicting the interference experienced by the receiving UE. Similarly, poor channel conditions (e.g., high pathloss, low received signal power) between the COT-initiating UE and the receiving UE may also reduce the confidence of the clear channel assessments in predicting the interference experienced by the receiving UE.

In some aspects, the schemes and mechanisms described herein may include a COT-initiating UE transmitting, to a COT-sharing UE, a list indicating one or more UEs eligible to receive communications during a shared portion of the COT. The list may be generated, determined, or otherwise created based on a comparison of the estimated distances between the COT-initiating UE and one or more other UEs and a configured distance threshold. In another aspect, the list may be generated, determined, or otherwise created based on a comparison of the estimated channel conditions (e.g., pathloss, received signal power) between the COT-initiating UE and one or more other UEs and a configured channel condition threshold.

The schemes, mechanisms, and associated aspects of the present disclosure provide several advantages. For example, although a UE that receives a COT sharing indication may not have data and/or signaling to transmit to the COT-initiating UE, the COT sharing UE may still make use of the resources in the shared frequency band by transmitting scheduled data and/or signaling with another UE. Further, communicating in the shared COT based on the distance and/or channel conditions between the COT-initiating UE and the receiving UE may decrease the chances of collisions in the shared frequency band, thereby making more efficient use of network resources, decreasing overhead and power waste, and improving user experience.

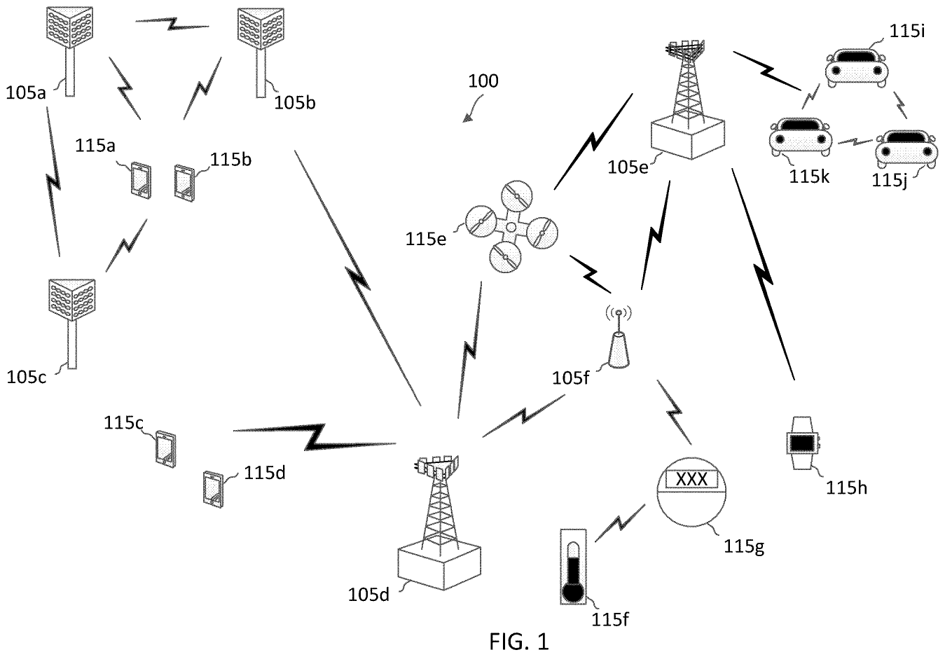

FIG. 1 illustrates a wireless communication network 100 according to some aspects of the present disclosure. The network 100 includes a number of base stations (BSs) 105 and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of an evolved NodeB (eNB) or an access node controller (ANC)) may interface with the core network 130 through backhaul links (e.g., S1, S2, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a vehicle (e.g., a car, a truck, a bus, an autonomous vehicle, an aircraft, a boat, etc.). Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-hop configurations by communicating with another user device which relays its information to the network, such as the UE 115f communicating temperature measurement information to the smart meter, the UE 115g, which is then reported to the network through the small cell BS 105f. In some aspects, the UE 115h may harvest energy from an ambient environment associated with the UE 115h. The network 100 may also provide additional network efficiency through dynamic, low-latency TDD/FDD communications, such as vehicle-to-vehicle (V2V), vehicle-to-everything (V2X), cellular-vehicle-to-everything (C-V2X) communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some instances, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes, for example, about 10. Each subframe can be divided into slots, for example, about 2. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information-reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some instances, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some instances, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining minimum system information (RMSI), and other system information (OSI)) to facilitate initial network access. In some instances, the BSs 105 may broadcast the PSS, the SSS, and/or the MIB in the form of synchronization signal blocks (SSBs) over a physical broadcast channel (PBCH) and may broadcast the RMSI and/or the OSI over a physical downlink shared channel (PDSCH).

In some instances, a UE 115 attempting to access the network 100 may perform an initial cell search by detecting a PSS from a BS 105. The PSS may enable synchronization of period timing and may indicate a physical layer identity value. The UE 115 may then receive an SSS. The SSS may enable radio frame synchronization, and may provide a cell identity value, which may be combined with the physical layer identity value to identify the cell. The SSS may also enable detection of a duplexing mode and a cyclic prefix length. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical uplink control channel (PUCCH), physical uplink shared channel (PUSCH), power control, SRS, and cell barring.

After obtaining the MIB, the RMSI and/or the OSI, the UE 115 can perform a random access procedure to establish a connection with the BS 105. For the random access procedure, the UE 115 may transmit a random access preamble and the BS 105 may respond with a random access response. Upon receiving the random access response, the UE 115 may transmit a connection request to the BS 105 and the BS 105 may respond with a connection response (e.g., contention resolution message).

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The BS 105 may transmit a DL communication signal to the UE 115 via a PDSCH according to a DL scheduling grant. The UE 115 may transmit a UL communication signal to the BS 105 via a PUSCH and/or PUCCH according to a UL scheduling grant.

The network 100 may be designed to enable a wide range of use cases. While in some examples a network 100 may utilize monolithic base stations, there are a number of other architectures which may be used to perform aspects of the present disclosure. For example, a BS 105 may be separated into a remote radio head (RRH) and baseband unit (BBU). BBUs may be centralized into a BBU pool and connected to RRHs through low-latency and high-bandwidth transport links, such as optical transport links. BBU pools may be cloud-based resources. In some aspects, baseband processing is performed on virtualized servers running in data centers rather than being co-located with a BS 105. In another example, based station functionality may be split between a remote unit (RU), distributed unit (DU), and a central unit (CU). An RU generally performs low physical layer functions while a DU performs higher layer functions, which may include higher physical layer functions. A CU performs the higher RAN functions, such as radio resource control (RRC).

For simplicity of discussion, the present disclosure refers to methods of the present disclosure being performed by base stations, or more generally network entities, while the functionality may be performed by a variety of architectures other than a monolithic base station. In addition to disaggregated base stations, aspects of the present disclosure may also be performed by a centralized unit (CU), a distributed unit (DU), a radio unit (RU), a Near-Real Time (Near-RT) RAN Intelligent Controller (RIC), a Non-Real Time (Non-RT) RIC, integrated access and backhaul (IAB) node, a relay node, a sidelink node, etc.

In some aspects, the UE 115i may perform a listen-before-talk (LBT) procedure. The UE 115i may acquire a channel occupancy time (COT) based on the LBT procedure being successful. The UE 115i may transmit COT sharing information to the UE 115j during the COT for sharing the COT with the UE 115j.

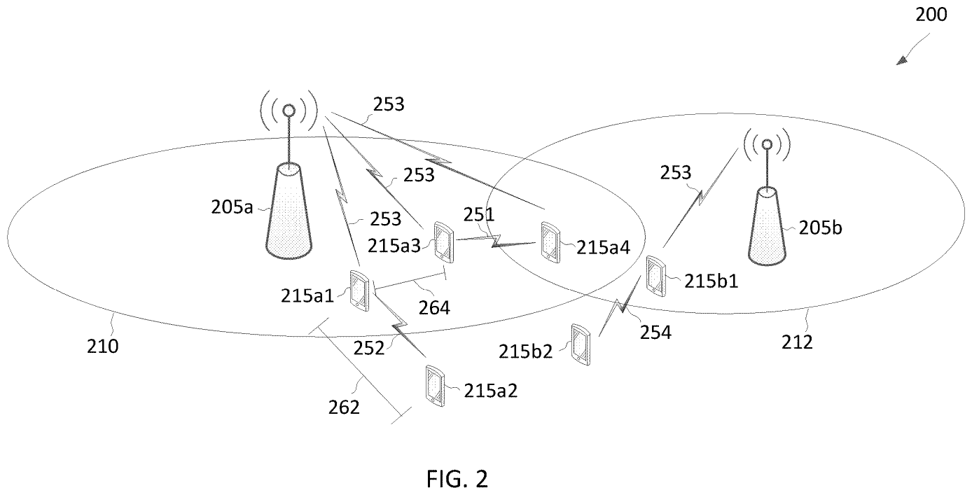

FIG. 2 illustrates an example of a wireless communication network 200 that provisions for sidelink communications according to aspects of the present disclosure. The network 200 may correspond to a portion of the network 100. FIG. 2 illustrates two BSs 205 (shown as 205a and 205b) and six UEs 215 (shown as 215a1, 215a2, 215a3, 215a4, 215b1, and 215b2) for purposes of simplicity of discussion, though it will be recognized that aspects of the present disclosure may scale to any suitable number of UEs 215 (e.g., the about 2, 3, 4, 5, 7 or more) and/or BSs 205 (e.g., the about 1, 3 or more). The BS 205 and the UEs 215 may be similar to the BSs 105 and the UEs 115, respectively. The BSs 205 and the UEs 215 may share the same radio frequency band for communications. In some instances, the radio frequency band may be a 2.4 GHz unlicensed band, a 5 GHz unlicensed band, or a 6 GHz unlicensed band. In general, the shared radio frequency band may be at any suitable frequency.

The BS 205a and the UEs 215a1-215a4 may be operated by a first network operating entity. The BS 205b and the UEs 215b1-215b2 may be operated by a second network operating entity. In some aspects, the first network operating entity may utilize a same RAT as the second network operating entity. For instance, the BS 205a and the UEs 215a1-215a4 of the first network operating entity and the BS 205b and the UEs 215b1-215b2 of the second network operating entity are NR-U devices. In some other aspects, the first network operating entity may utilize a different RAT than the second network operating entity. For instance, the BS 205a and the UEs 215a1-215a4 of the first network operating entity may utilize NR-U technology while the BS 205b and the UEs 215b1-215b2 of the second network operating entity may utilize WiFi or LAA technology.

In the network 200, some of the UEs 215a1-215a4 may communicate with each other in peer-to-peer communications. For example, the UE 215a1 may communicate with the UE 215a2 over a sidelink 252, the UE 215a3 may communicate with the UE 215a4 over another sidelink 251, and the UE 215b1 may communicate with the UE 215b2 over yet another sidelink 254. The sidelinks 251, 252, and 254 are unicast bidirectional links. Some of the UEs 215 may also communicate with the BS 205a or the BS 205b in a UL direction and/or a DL direction via communication links 253. For instance, the UE 215a1, 215a3, and 215a4 are within a coverage area 210 of the BS 205a, and thus may be in communication with the BS 205a. The UE 215a2 is outside the coverage area 210, and thus may not be in direct communication with the BS 205a. In some instances, the UE 215a1 may operate as a relay for the UE 215a2 to reach the BS 205a. Similarly, the UE 215b1 is within a coverage area 212 of the BS 205b, and thus may be in communication with the BS 205b and may operate as a relay for the UE 215b2 to reach the BS 205b. In some aspects, some of the UEs 215 are associated with vehicles (e.g., similar to the UEs 115i-k) and the communications over the sidelinks 251, 252, and 254 may be C-V2X communications. C-V2X communications may refer to communications between vehicles and any other wireless communication devices in a cellular network.

In some aspects, the UEs 215 may communicate with one another based on a distance between them. For example, the UEs 215a1 and 215a2 may be separated by a distance 262. In some aspects, one or both of the UEs 215a1, 215a2 may be configured to determine the distance 262 based on one or more indications from the other UE. For example, one or both of the UEs 215a1, 215a2 may be configured to transmit a signal indicating a zone identifier (ID) indicating a global location or zone of the UE. Accordingly, the zone ID may be used as a representation of the UE's global position to estimate or determine the distance 262. In some aspects, the distance 262 may be sufficiently large to affect one or more aspects of communications between the UEs 215a1, 215a2. For example, the distance 262 may be sufficiently large such that a pathloss between the UEs 215a1, 215a2 creates communication difficulties. In another aspect, if the distance 262 is large, the interferences experienced by each of the UEs 215a1, 215a2 may be significantly different such that interference experienced by one of the UEs 215a1, 215a2 may be a poor representation of the interference experienced by the other of the UEs 215a1, 215a2. Thus, a channel assessment (e.g., clear channel assessment, LBT, etc.) made by UE 215a1 to initiate a channel occupancy time (COT) may not consider the extent of interference experienced by UE 215a2 during the COT. However, in another aspect, the distance 264 between the UE 215a1 and the UE 215a3 may be sufficiently small such that a CCA performed by UE 215a1 may sufficiently estimate channel conditions experienced by the UE 215a3. Further, the pathloss experienced for communications between the UE 215a1 and the UE 215a3 may be less than that of the communications between the UE 215a1 and the UE 215a2.

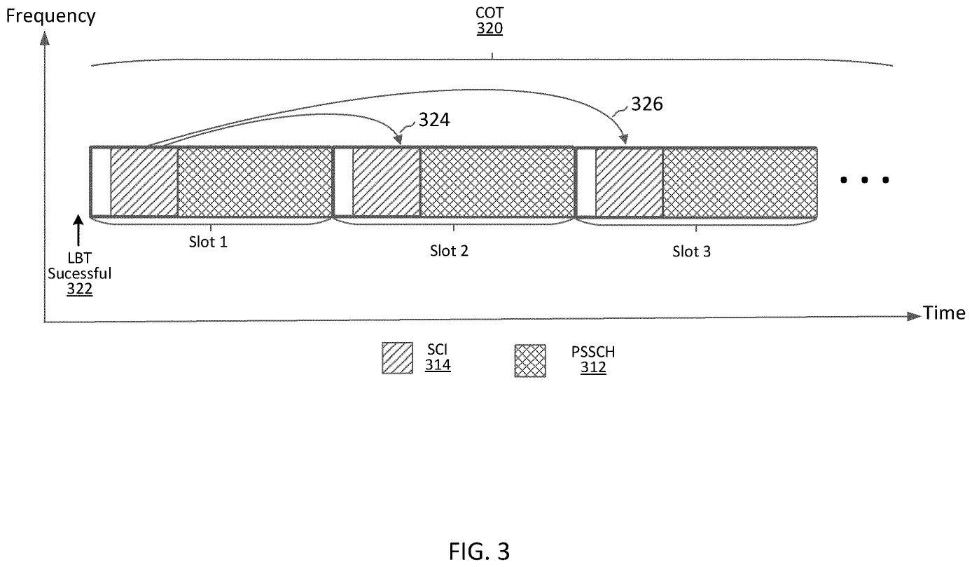

FIG. 3 illustrates an example of COT sharing resources according to some aspects of the present disclosure. In FIG. 3, the x-axis represents time in some arbitrary units and the Y axis represents frequency in some arbitrary units. In some aspects, a first sidelink UE (e.g., the UE 115, or the UE 700) may perform a listen-before-talk (LBT) procedure to gain access to the COT 320. The first sidelink UE may perform the LBT procedure or other clear channel assessment (CCA) on one or more sidelink communication channels. In some instances, the first sidelink UE may perform an LBT procedure or other CCA to gain access to the COT 320 in an unlicensed (e.g., shared) frequency spectrum. For example, the first sidelink UE may perform a category 1 LBT, a category 2 LBT, a category 3 LBT, and/or a category 4 LBT to gain access to the COT 320 in an unlicensed frequency spectrum. In some aspects, the first sidelink UE may perform the LBT in one or more time resources, spatial resources, and/or frequency resources. The frequency resources may include a frequency spectrum, a frequency band, a frequency sub-band, a frequency subchannel, resource elements, resource blocks, and/or a frequency interlace. The time resources may include slot(s), sub-slot(s), symbol(s), subframe(s), or any other suitable time resources. In some aspects, the first sidelink UE may perform the LBT for one or more directional beams (e.g., a beam in the direction of the UE that the first sidelink UE intends to transmit a communication to and/or receive a communication from).

The first sidelink UE may acquire the COT 320 based on the LBT procedure 322 being successful. The first sidelink UE may acquire the COT 320 to transmit a communication to another sidelink UE. Additionally or alternatively, the first sidelink UE may share the COT with other sidelink UEs.

The first sidelink UE may transmit COT sharing information to a second sidelink UE (e.g., the UE 115, a UE 215, or the UE 700) for sharing the COT 320 with the second sidelink UE. The first sidelink UE may transmit the COT sharing information to the second sidelink UE during the COT 320 as indicated by arrow 324. The COT sharing information may include a COT resource allocation that indicates resources the second sidelink UE may use to share the COT 320. In some aspects, the first sidelink UE may transmit the COT sharing information to the second sidelink UE and other sidelink UEs (e.g., a group of sidelink UEs, a set of sidelink UEs). The first sidelink UE may transmit the COT sharing information including resource allocations to the set of sidelink UEs to share the COT with the set of sidelink UEs. For example, the first sidelink UE may transmit the COT sharing information to a third sidelink UE as indicated by arrow 326.

In some aspects, the first sidelink UE may transmit the COT sharing information via sidelink control information (SCI) 314 (e.g., SCI-1, SCI-2), an RRC message, a PSCCH message, a PSSCH 312 message, or other suitable communication. For example, the first sidelink UE may transmit the COT sharing information in a SL_COT_SharingInformation field via sidelink control information 2 (SCI-2).

In some aspects, the COT sharing information may include information (e.g., parameters, resources, settings, commands, etc.) to enable the first sidelink UE to share the COT 320 with other sidelink UEs (e.g., the second sidelink UE). Sharing the COT 320 with other sidelink UEs may enable the other sidelink UEs to transmit and/or receive communications during the COT 320 in an efficient and coordinated fashion. In some aspects, the COT sharing information may include identifiers associated with the set of sidelink UEs that share the COT 320 The sidelink UE identifiers may include layer one identifiers unique to each sidelink UE that shares the COT.

In some aspects, the COT sharing information may include a time resource allocation associated with the COT sharing. For example, the time resource allocation may include a COT start time, a COT end time, and/or a COT duration. The time resource allocation may include time resources (e.g., slots, sub-slots, symbols, frames, etc.) allocated to the set of sidelink UEs that share the COT 320. For example, the time resource allocation may indicate index(s) indicating starting slot(s) and/or sub-slot(s) allocated to the set of sidelink UEs. The time resource allocation may indicate a number of time resources (e.g., a number of slots, sub-slots, and/or symbols) allocated to the set of sidelink UEs. For example, the time resource allocation may indicate slot 1 is allocated to the first sidelink UE, slot 2 is allocated to the second sidelink UE, and slot 3 is allocated to the third sidelink UE. The first sidelink UE may indicate the time resource allocation(s) to the sidelink UEs sharing the COT in a time domain resource allocation (TDRA) via SCI-1.

In some aspects, the time resource allocation included in the COT sharing information may indicate time resources associated with sharing the COT relative to when the LBT procedure 322 is successful. For example, if the first sidelink UE performs a successful LBT 322 at slot i, then the time resource allocation may indicate the resources associated with COT sharing relative to slot i. In some instances, the time resource allocation may indicate the resources associated with COT sharing as a number (e.g., an integer number) of slots, a number of sub-slots, or a number of symbols from slot i (e.g., the end of slot i and/or the beginning of slot i). In some aspects, the time resource allocation may indicate the resources associated with COT sharing as a time value (e.g., number of milliseconds) relative to slot i.

In some aspects, the COT sharing information may indicate a COT duration. The COT duration may indicate a time period for sidelink UEs to share the COT 320 during which the first sidelink UE and the COT sharing UE(s) may communicate. The COT duration may start from a successful LBT 322 by the first sidelink UE. In some aspects, the COT duration may be based on an amount of data (e.g., transport blocks) the first sidelink UE and/or the COT sharing UE(s) need to transmit. A larger amount of data may require a longer COT duration as compared to a smaller amount of data. The COT duration may be indicated to the COT sharing UE(s) as a number of slots, a number of sub-slots, a number of symbols, a number of milliseconds, or a combination thereof. In some aspects, the COT duration may be indicated as a remaining COT duration. For example, the COT duration may be a duration of x slots. The first sidelink UE may use y slots of the x slots to transmit sidelink communications. The remaining COT duration may be indicated to the second sidelink UE and/or other COT sharing sidelink UEs as x-y slots.

In some aspects, the COT sharing information may include a frequency resource allocation (e.g., frequency range(s)) associated with the COT sharing. For example, the frequency resource allocation may include a starting frequency (e.g., a starting frequency subchannel index, a starting frequency band, a starting frequency interlace). The frequency resource allocations may include an ending frequency (e.g., an ending subchannel, an ending frequency band). The frequency resource allocations may include a frequency interlace (e.g., a frequency interlace index, indexes of subchannels). The frequency resource allocation may indicate frequency resources allocated to the set of sidelink UEs that share the COT 320 with the first sidelink UE. The first sidelink UE may indicate the frequency resource allocation(s) to the sidelink UEs sharing the COT 320 in a frequency domain resource allocation (FDRA) via SCI-1.

In some aspects, the first sidelink UE may transmit a flag indicating the first sidelink UE is sharing the COT 320. In this regard, the first sidelink UE may transmit the flag via SCI 314 (e.g., SCI-1, SCI-2) indicating the first sidelink UE is sharing the COT 320. The flag may include a single bit (e.g., 0 or 1) indicator, a multi-bit indicator, a code point, or other indicator to indicate the other sidelink UEs (e.g., the sidelink UEs receiving the flag) may share the COT 320.

In some aspects, the first sidelink UE may transmit the flag in SCI-2 via a PSSCH 312. The SCI-2 may include destination identifier(s) associated with the second sidelink UE and other sidelink UEs indicating the first sidelink UE shares the COT 320 with the second sidelink UE and the other sidelink UEs. The sidelink UEs in proximity to the first sidelink UE that receive and decode the SCI-2 may share the COT 320 with the first sidelink UE if the SCI-2 includes an identifier that matches the identifier associated with the receiving sidelink UE.

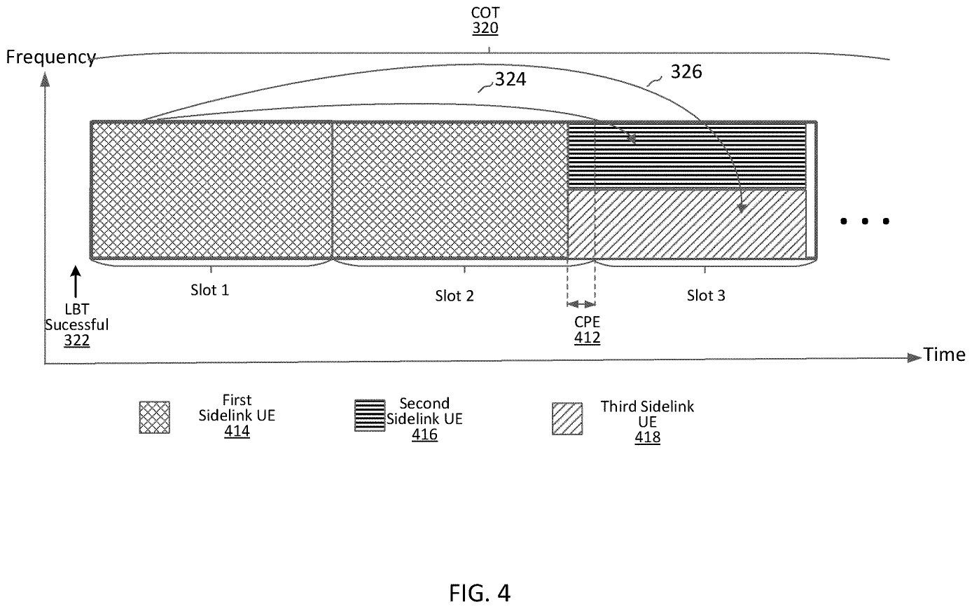

FIG. 4 illustrates an example of COT sharing using frequency division multiplexed resources according to some aspects of the present disclosure. In FIG. 4, the x-axis represents time in some arbitrary units and the Y axis represents frequency in some arbitrary units. In some aspects, a first sidelink UE (e.g., the UE 115, a UE 215, or the ULE 700) may perform a listen-before-talk (LBT) procedure 322 to gain access to the COT 320. The first sidelink UE may perform the LBT procedure 322 or other clear channel assessment (CCA) on one or more sidelink communication channels. In some instances, the first sidelink UE may perform an LBT procedure 322 or other CCA to gain access to the COT 320 in an unlicensed (e.g., shared) frequency spectrum. For example, the first sidelink UE may perform a category 1 LBT, a category 2 LBT, a category 3 LBT, and/or a category 4 LBT to gain access to the COT 320 in an unlicensed frequency spectrum.

The first sidelink UE may acquire the COT 320 based on the LBT procedure 322 being successful. The first sidelink UE may acquire the COT 320 to transmit a communication to another sidelink UE. Additionally or alternatively, the first sidelink UE may share the COT with other sidelink UEs.

The first sidelink UE may transmit COT sharing information to a second sidelink ULE (e.g., the UE 115, a UE 215, or the UE 700) for sharing the COT 320 with the second sidelink UE. The first sidelink UE may transmit the COT sharing information in slot 1 to the second sidelink UE as indicated by arrow 324. The COT sharing information may include a COT resource allocation that indicates resources the second sidelink UE may use to share the COT 320. In some aspects, the first sidelink UE may transmit the COT sharing information to the second sidelink UE and other sidelink UEs (e.g., a group of sidelink UEs, a set of sidelink UEs). The first sidelink UE may transmit the COT sharing information including resource allocations to the set of sidelink UEs to share the COT with the set of sidelink UEs. For example, the first sidelink UE may transmit the COT sharing information to a third sidelink UE as indicated by arrow 326.

In some aspects, the COT sharing information may include a time resource allocation associated with the COT sharing. For example, the time resource allocation may include a COT start time, a COT end time, and/or a COT duration. The time resource allocation may include time resources (e.g., slots, sub-slots, symbols, frames, etc.) allocated to the set of sidelink UEs that share the COT. For example, the time resource allocation may indicate index(s) indicating starting slot(s) and/or sub-slot(s) allocated to the set of sidelink UEs. The time resource allocation may indicate a number of time resources (e.g., a number of slots, sub-slots, and/or symbols) allocated to the set of sidelink UEs. For example, the time resource allocation 414 may indicate slots 1 and 2 are allocated to the first sidelink UE and slot 3 is allocated to the second and third sidelink UEs. The first sidelink UE may indicate the time resource allocation(s) to the sidelink UEs sharing the COT in a time domain resource allocation (TDRA) via SCI-1.

In some aspects, the first sidelink UE may transmit the COT sharing information to a second and third sidelink UE for sharing the COT 320. The COT sharing information may indicate frequency resources 416 allocated to the second sidelink UE frequency division multiplexed with frequency resources 418 allocated to the third sidelink UE. In some aspects, the COT sharing information may indicate the same cyclic prefix extension (CPE) length 412 allocated to the second sidelink UE and the third sidelink UE. By having the same CPE length 412, the second and third sidelink UEs may each transmit a sidelink communication at the same in slot 3 but the sidelink transmissions may not interfere with one another due to the second and third sidelink UEs transmitting in different frequency ranges 416 and 418. In some aspects, the second and third sidelink UEs may perform an LBT (e.g., CAT 1 LBT, CAT 2 LBT) prior to transmitting in slot 3 based on the time gap between the end of the first sidelink UE's transmission in slot 2 and the CPE length 412 indicated by the COT sharing information.

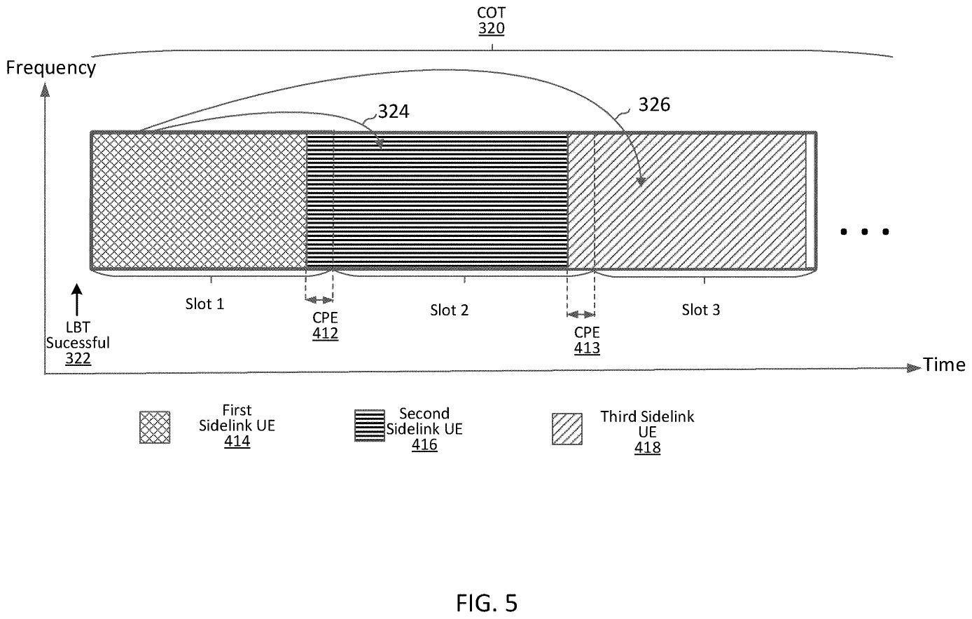

FIG. 5 illustrates an example of COT sharing using time division multiplexed resources according to some aspects of the present disclosure. In FIG. 5, the x-axis represents time in some arbitrary units and the Y axis represents frequency in some arbitrary units. In some aspects, a first sidelink UE (e.g., the UE 115, a UE 215, or the LIE 700) may perform a listen-before-talk (LBT) procedure to gain access to the COT 320. The first sidelink UE may perform the LBT procedure or other clear channel assessment (CCA) on one or more sidelink communication channels. In some instances, the first sidelink UE may perform an LBT procedure or other CCA to gain access to the COT 320 in an unlicensed (e.g., shared) frequency spectrum. For example, the first sidelink UE may perform a category 1 LBT, a category 2 LBT, a category 3 LBT, and/or a category 4 LBT to gain access to the COT 320 in an unlicensed frequency spectrum.

The first sidelink UE may acquire the COT 320 based on the LBT procedure 322 being successful. The first sidelink UE may acquire the COT 320 to transmit a communication to another sidelink UE. Additionally or alternatively, the first sidelink UE may share the COT with other sidelink UEs.

The first sidelink UE may transmit COT sharing information to a second sidelink ULE (e.g., the UE 115, a UE 215, or the UE 700) for sharing the COT 320 with the second sidelink UE. The first sidelink UE may transmit the COT sharing information in slot 1 to the second sidelink UE as indicated by arrow 324. The first sidelink UE may transmit the COT sharing information to a third sidelink UE as indicated by arrow 326.

In some aspects, the COT sharing information may include a time resource allocation associated with the COT sharing. For example, the time resource allocation may include a COT start time, a COT end time, and/or a COT duration. The time resource allocation may indicate slot 1 is allocated to the first sidelink UE, slot 2 is allocated to the second sidelink UE, and slot 3 is allocated to the third sidelink UE. The first sidelink UE may indicate the time resource allocation(s) to the sidelink UEs sharing the COT in a time domain resource allocation (TDRA) via SCI-1.

The COT sharing information may indicate time resources allocated to the second sidelink UE time division multiplexed with time resources allocated to the third sidelink UE. For example, the first sidelink UE may transmit in slot 1, the second sidelink ULE may transmit in slot 2, and the third sidelink UE may transmit in slot 3. Slots 1, 2, and 3 may be contiguous or non-contiguous. The first, second, and third sidelink UEs may transmit in the same frequency range(s) or different frequency range(s). In some aspects, the COT sharing information may indicate the same CPE length 412, 413 allocated to the second sidelink UE and the third sidelink UE respectively. In some aspects, the COT sharing information may indicate different CPE lengths 412, 413 allocated to the second sidelink UE and the third sidelink UE. The second and third sidelink UEs may each transmit a sidelink communication in their respective time allocations and not interfere with one another due to transmitting at different times. In some aspects, the second and third sidelink UE may perform an LBT (e.g., CAT 1 LBT, CAT 2 LBT) based on the time gap between the end of the first sidelink UE's transmission and the CPE length 412, 413 indicated for the second and third sidelink UEs respectively.

As explained above, it may be desirable to allow a UE sharing a COT to transmit SL communications to one or more UEs other than the COT-initiating UE. For example, a first UE may initiate a COT and share a portion of the COT with a second UE. The second UE may have an SL communication scheduled for a third UE. For example, the second UE may have SL feedback information to communicate to the third UE during the shared portion of the COT. Although the second UE may also perform a channel access procedure before communicating in the shared portion of the COT, neither the first channel access procedure performed by the first UE nor the second channel access procedure performed by the second UE may adequately represent the interference or channel conditions experienced by the third UE that would receive the SL communication from the second UE. For example, the distance between the first UE and the third UE may be significantly large, or the environment may create a large pathloss for communications to the third UE. The present disclosure describes schemes and mechanisms for communicating during shared portions of COTs based on one or more COT sharing eligibility parameters. In some aspects, the COT sharing eligibility parameters may include a distance between the COT-initiating UE and the receiving UE. In another aspect, the COT sharing eligibility parameters may include one or more channel conditions between the COT-initiating UE and the receiving UE. Further aspects will become clear with the following description and corresponding figures.

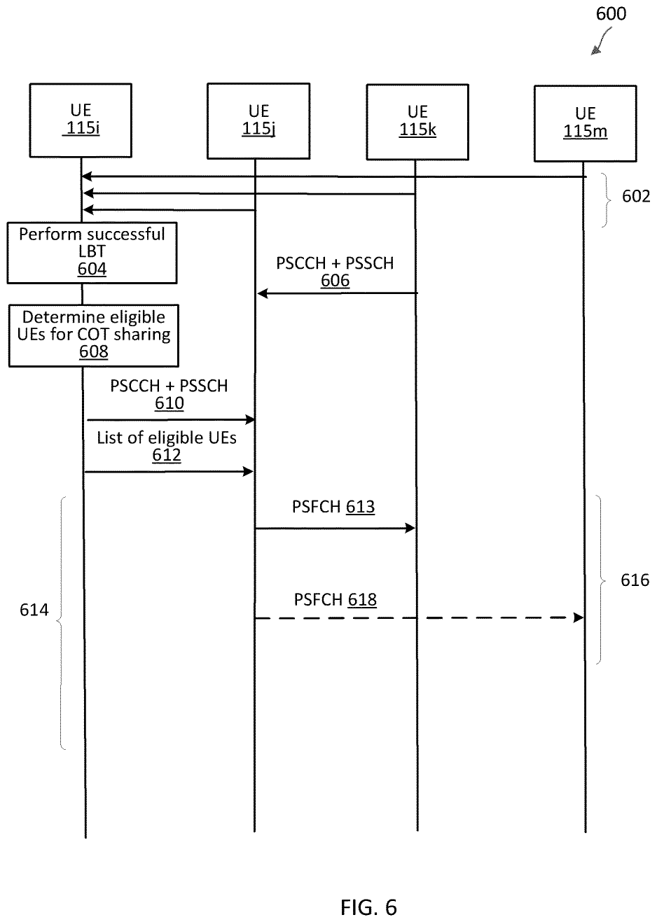

FIG. 6 is a signaling diagram of a wireless communication method 600 according to some aspects of the present disclosure. Actions of the communication method 600 can be executed by a computing device (e.g., a processor, processing circuit, and/or other suitable component) of a communication device or other suitable means for performing the actions. For example, a wireless communication device, such as the UE 115, UE 215, or UE 700, may utilize one or more components, such as the processor 702, the memory 704, the COT sharing module 708, the transceiver 710, the modem 712, and the one or more antennas 716, to execute aspects of method 600.

At action 602, one or more of the UEs 115j, 115k, and/or 115m transmit SL communications to the UE 115i. In some aspects, the UE 115i may be referred to as the COT-initiating UE, as will become clear below. In some aspects, the SL communications may comprise one or more of PSCCH, PSSCH, PSFCH, and/or SL references signals (e.g., S-SRS). In some aspects, the SL communications may include or carry one or more demodulation reference signals (DMRS). For example, the SL communications may comprise PSSCH communications including DMRS. In another example, the SL communications may include SCI indicating a zone id or other location-based information associated with the corresponding UE. For example, UE 115j may transmit a first SL communication comprising a PSCCH and a PSSCH. The PSSCH may include or carry SCI-2 indicating a Zone ID of the UE 115j. The Zone ID may be based on a global coordinate system. In another aspect, the SCI-2 may include or indicate other location-based information of the UE 115j, such as a relative location of the UE 115j with respect to the UE 115i.

At action 604, the UE 115i may perform a successful LBT. The UE 115i may perform a category 1 LBT, a category 2 LBT, a category 3 LBT, and/or a category 4 LBT to gain access to the COT in an unlicensed frequency spectrum. In some aspects, the UE 115i may perform the LBT based on a configured energy detection threshold. In another aspect, performing the LBT may comprise determining or measuring a quantified interference energy, as explained further below.

At action 606, the UE 115k transmits a SL communication to the UE 115j. In some aspects, the SL communication comprises at least one of a PSCCH and/or a PSSCH communication. In some aspects, the UE 115j may be configured with SL feedback resources such as physical sidelink feedback channel (PSFCH) resources for providing ACK/NACK to UEs. Accordingly, receiving the SL communication at action 606 may trigger or cause the UE 115j to transmit a PSFCH signal in a following PSFCH occasion.

At action 608, the UE 115i determines, based on the SL communications received at action 602, whether each of the UEs 115j, 115k, and/or 115m is/are eligible for receiving communications during a shared portion of a COT. In some aspects, the determination may be based on a location of each of the UEs 115j, 115k, and/or 115m. For example, the determination may be based on a distance between the UE 115i and each of the UEs 115j, 115k, and/or 115m. In some aspects, the UE 115i may determine the distance between the UE 115i and each of the other UEs 115j, 115k, and/or 115m based on the location information provided by each of the UEs 115j, 115k, and/or 115m at action 602. For example, the UE 115i may determine the distance based on a comparison of its own Zone ID with the Zone IDs of each of the UEs 115j, 115k, and/or 115m.

In some aspects, action 608 may comprise the UE 115i comparing each distance to a distance threshold. In some aspects, the UE 115i may be configured with one or more distance thresholds for determining whether one or more UEs are eligible for receiving communications from a different UE during a shared portion of a COT initiated by the UE 115i. In some aspects, the UE 115i may be configured with a plurality of distance thresholds for the determination at action 608. In this regard, the thresholds used by the UE 115i to identify eligible UEs may be based on one or more configurations, parameters, or measurements associated with the LBT performed at action 604. For example, each distance threshold may correspond to one of two or more configured energy detection thresholds associated with the LBT performed at action 604. In this regard, each of the UEs 115 may be configured with at least one energy detection threshold of a plurality of possible energy detection thresholds. The UE 115i may apply a first distance threshold if a first energy detection threshold is configured at the UE 115i for the LBT performed at action 604, and may apply a different second distance threshold if a different second energy detection threshold is configured. The distance thresholds used for a plurality of different energy detection thresholds is shown in table 1 below.

TABLE 1

| Energy | | Reference Signal | |
|---|---|---|---|
| Detection | Distance | Received Power | Pathloss |
| Threshold | Threshold | (RSRP) Threshold | Threshold |
| −72 dBm | Threshold A1 | Threshold B1 | Threshold C1 |
| −82 dBm | Threshold A2 | Threshold B2 | Threshold C2 |

In another aspect, the distance threshold applied by the UE 115i may be based on or associated with a quantified interference energy the LBT performed at action 604. For example, the UE 115i may select one of a plurality of distance thresholds based on an amount of quantified interference energy detected during the LBT. For example, the UE 115i may use, for a first quantified interference energy, a first distance threshold for determining whether the UEs 115j, 115k, and/or 115m is/are eligible for COT sharing. The UE 115i may use, for a second quantified interference energy, a second distance threshold for determining whether the UEs 115j, 115k, and/or 115m is/are eligible for COT sharing. The UE 115i may use, for a third quantified interference energy, a third distance threshold for determining whether the UEs 115j, 115k, and/or 115m is/are eligible for COT sharing. The distance thresholds used for a plurality of different quantified interference energy levels is shown in table 2 below.

TABLE 2

| Energy | | | |
|---|---|---|---|
| Detection | Distance | RSRP | Pathloss |
| Threshold | Threshold | Threshold | Threshold |
| −65 dBm | Threshold A3 | Threshold B3 | Threshold C3 |
| −75 dBm | Threshold A4 | Threshold B4 | Threshold C4 |
| −85 dBm | Threshold A5 | Threshold B5 | Threshold C5 |

In some aspects, the determination may be based on channel conditions between the UE 115i and each of the UEs 115j, 115k, and/or 115m. For example, the determination may be based on a reference signal received power (RSRP) and/or a pathloss between the UE 115i and each of the UEs 115j, 115k, and/or 115m. In some aspects, the UE 115i may determine the RSRP between the UE 115i and each of the other UEs 115j, 115k, and/or 115m based on DMRS in the PSSCH transmitted by each of the UEs 115j, 115k, and/or 115m at action 602. In another aspect, the UE 115i may perform one or more PSSCH transmissions to each of the UEs 115j, 115k, and/or 115m. Each of the UEs 115j, 115k, 115m may measure RSRP based on the transmitted PSSCH DMRS and indicate the RSRP to the UE 115i using higher layer signaling. UE 115i may determine the pathloss between the UE 115i and each of the other UEs 115j, 115k, and/or 115m based on the transmit power used to transmit each PSSCH DMRS and the indicated RSRP indication provided by the UEs 115j, 115k, and/or 115m.

In some aspects, action 608 may comprise the UE 115i comparing each RSRP and/or pathloss to a RSRP threshold and/or a pathloss threshold. In some aspects, the UE 115i may be configured with one or more RSRP thresholds for determining whether one or more UEs are eligible for receiving communications from a different UE during a shared portion of a COT initiated by the UE 115i. In some aspects, the UE 115i may be configured with a plurality of RSRP thresholds for the determination at action 604. For example, each RSRP threshold may correspond to one of two or more configured energy detection thresholds. In this regard, each of the UEs 115 may be configured with at least one energy detection threshold of a plurality of possible energy detection thresholds. The UE 115i may apply a first RSRP threshold if a first energy detection threshold is configured at the UE 115i for the LBT performed at action 604, and may apply a different second RSRP threshold if a different second energy detection threshold is configured. The RSRP thresholds used for a plurality of different energy detection thresholds is shown in table 1 above.

In another aspect, the RSRP threshold applied by the UE 115i may be based on or associated with a quantified interference energy for the LBT performed at action 604. For example, the UE 115i may select one of a plurality of RSRP thresholds based on an amount of quantified interference energy detected during the LBT. For example, the UE 115i may use, for a first quantified interference energy, a first RSRP threshold for determining whether the UEs 115j, 115k, and/or 115m is/are eligible for COT sharing. The UE 115i may use, for a second quantified interference energy, a second RSRP threshold for determining whether the UEs 115j, 115k, and/or 115m is/are eligible for COT sharing. The UE 115i may use, for a third quantified interference energy, a third RSRP threshold for determining whether the UEs 115j, 115k, and/or 115m is/are eligible for COT sharing. The distance thresholds used for a plurality of different quantified interference energy levels is shown in table 2 above.

In some aspects, the UE 115i may be configured with one or more pathloss thresholds for determining whether one or more UEs are eligible for receiving communications from a different UE during a shared portion of a COT initiated by the UE 115i. In some aspects, the UE 115i may be configured with a plurality of pathloss thresholds for the determination at action 608. For example, each pathloss threshold may correspond to one of two or more configured energy detection thresholds. In this regard, each of the UEs 115 may be configured with at least one energy detection threshold of a plurality of possible energy detection thresholds. The UE 115i may apply a first pathloss threshold if a first energy detection threshold is configured at the UE 115i for the LBT performed at action 604, and may apply a different second pathloss threshold if a different second energy detection threshold is configured. The pathloss thresholds used for a plurality of different energy detection thresholds is shown in table 1 above.

In another aspect, the pathloss threshold applied by the UE 115i may be based on or associated with a quantified interference energy for the LBT. For example, the UE 115i may select one of a plurality of pathloss thresholds based on an amount of quantified interference energy detected during the LBT. For example, the UE 115i may use, for a first quantified interference energy, a first pathloss threshold for determining whether the UEs 115j, 115k, and/or 115m is/are eligible for COT sharing to receive from a non-COT-initiating UE. The UE 115i may use, for a second quantified interference energy, a second pathloss threshold for determining whether the UEs 115j, 115k, and/or 115m is/are eligible for COT sharing to receive from a non-COT-initiating UE. The UE 115i may use, for a third quantified interference energy, a third pathloss threshold for determining whether the UEs 115j, 115k, and/or 115m is/are eligible for COT sharing to receive from a non-COT-initiating UE. The distance thresholds used for a plurality of different quantified interference energy levels is shown in table 2 above.

In another aspect, the UE 115i may use multi-stage thresholds for determining a duration or amount of time during a shared portion of the COT during which each of the UEs 115j, 115k, and/or 115m may perform a transmission during a shared portion of the COT. The multi-stage thresholds may be multi-stage distance thresholds and/or multi-stage channel condition thresholds (e.g., RSRP threshold, pathloss threshold, etc.). In one example, the UE 115i compares a distance between UE 115k and the UE 115i to each of a first distance threshold, a second distance threshold, and a third distance threshold. Depending on which of the multi-stage distance thresholds are or are not satisfied, the UE 115i may determine the duration within the shared portion of COT during which the UE 115k may perform a transmission to a non-COT-initiating UE (e.g., UE 115j). In one example, if the distance between UE 115i and UE 115k satisfies all three thresholds (i.e. UE 115k is determined to be closer to the UE 115i than each of the multi-stage distance thresholds), the UE 115i may determine that the UE 115k may perform transmissions during an entirety of the shared portion of the COT. If the distance satisfies two of the three thresholds, the UE 115i may determine that the UE 115k may perform transmissions during only a portion of the shared portion of the COT (i.e. less than the entirety of the shared portion of the COT). If the UE 115i determines that the distance satisfies none of the multi-stage distance thresholds, the UE 115i may determine that the UE 115k may not perform any transmissions during the shared portion of the COT. An example threshold scheme is illustrated in table 3 below.

TABLE 3

| Energy | Threshold A (e.g., | | Multi-stage |
|---|---|---|---|
| Detection | distance, RSRP, | Multi-stage | threshold |
| Threshold | pathloss) | threshold | ordering |
| −72 dBm | Threshold A1 | Threshold 0 | <Threshold 1 |
| | | Threshold 1 | <Threshold 2 |
| | | Threshold 2 | =Threshold A1 |
| −82 dBm | Threshold A2 | Threshold 3 | <Threshold 4 |
| | | Threshold 4 | <Threshold 5 |
| | | Threshold 5 | =Threshold A2 |

As shown in table 3, a plurality of multi-stage candidate thresholds may be configured. The multi-stage candidate thresholds 0-5 may be distance thresholds and/or channel condition-based thresholds. The multi-stage thresholds are first divided into a firs threshold set A1 and a second threshold set A2 based on energy detection threshold, as explained above. In another aspect, the multi-stage thresholds may be divided into the threshold sets A1 and A2 based on quantified interference energy instead of or in addition to the energy detection threshold. For each energy detection threshold, a plurality of multi-stage thresholds are configured or indicated. For threshold A1, multi-stage thresholds having indices 0-2 are configured, where threshold 2 is the highest, or most relaxed threshold, and threshold 0 is the most stringent threshold. For example, if the multi-stage thresholds are distance thresholds, threshold 0 may correspond to a smaller distance than thresholds 1 and 2, and threshold 2 may correspond to a larger distance than thresholds 0 and 1. With reference to tables 1-3, it will be understood that the energy detection threshold values and the quantified interference energy values are exemplary and any suitable values may be used to determine or select a distance threshold and/or channel condition threshold. Further, with respect to tables 1-2, it will be understood that more than two energy detection thresholds may be configured, and that fewer or more than three quantified interference energy thresholds or levels may be configured for selecting a distance threshold and/or channel condition threshold.

The multi-stage thresholds described above may allow for UE 115i to determine a duration or portion of the shared portion of the COT during which the UEs 115j, 115k, and/or 115m may perform transmissions to a non-COT-initiating UE. For example, with reference to table 3, if energy detection threshold −72 dBm is configured and if the distance between UE 115i and UE 115k satisfies thresholds 2 and 1 but not threshold 0, the UE 115i may determine that the UE 115k may transmit during the first M μs of the shared portion of the COT, but not the remaining portion. If the UE 115i determines that the distance between UE 115i and UE 115k, satisfies threshold 2 but not thresholds 0 or 1, UE 115i may determine and indicate, to the UEs 115k, that the UE 115k may not transmit, during the shared portion of the COT, any unicast transmissions with user plane data, and that the UE 115k may transmit only during the first N μs of the shared portion of the COT, but not the remaining portion, where N<M. If UE 115i determines that the distance between UE 115i and the UE 115k satisfies none of thresholds 0-2, the UE 115i may determine that the UE 115k is ineligible to transmit to a non-COT-initiating UE during the shared portion of the COT.

At action 610, the UE 115i transmits, and the UE 115j receives, a SL communication based on the determination at action 608. In some aspects, the SL communication comprises at least one of a PSCCH and/or a PSSCH. In some aspects, the SL communication comprises SCI. The SL communication may indicate, to the UE 115j, that the UE 115i has initiated or acquired a COT. In another aspect, the SL communication may indicate, to the UE 115j that a portion 614 of the COT may be shared with and used by the UE 115j for transmitting one or more SL communications to the UE 115i and/or to one or more other UEs, such as the UEs 115k, 115m. In some aspects, the indication of the COT and/or the indication of COT sharing may be carried in a same SCI, or in separate SCIs. In some aspects, action 610 may comprise transmitting one or more SCI-2 indicating the COT and/or the COT sharing. For example, the UE 115i may transmit COT sharing information in a SL_COT_SharingInformation field via SCI-2. In some aspects, the COT sharing information may include information (e.g., parameters, resources, settings, commands, etc.) to enable the UE 115i to share the COT with the UEs 115j, 115k, and 115m. In some aspects, the COT sharing information may include identifiers associated with the set of sidelink UEs that share the COT. The sidelink UE identifiers may include layer one identifiers unique to each sidelink UE that shares the COT.

At action 612, the UE 115i transmits, and the UE 115j receives, a list of eligible UEs. In some aspects, action 612 comprises the UE 115i transmitting a PSCCH and/or a PSSCH carrying SCI indicating the list of eligible UEs. In some aspects, the list of eligible UEs may include a list of UE IDs (e.g., SL destination identifier) that are eligible for receiving communications during the shared portion 614 of the COT. In other aspects, action 612 may comprise the UE 115i transmitting one or more of a RRC message, a MAC-CE, and/or any other suitable type of SL communication indicating the list. In some aspects, the list may further indicate a plurality of COT sharing durations or portions during which one or more of the UEs 115j, 115k, and/or 115m may receive SL communications from the COT sharing UE 115j during the shared portion 614 of the COT. For example, the list may indicate that the UE 115k may receive during the entirety of the shared portion 614 of the COT, and that the UE 115m may receive during a portion 616 of the shared portion 614 of the COT. For example, the portion 616 of the shared portion 614 may comprise the first M μs of the shared portion 614 of the COT. The list may be based on a multi-stage threshold configuration in which multiple, staged distance or channel condition thresholds are used by the UE 115i to determine the appropriate durations for each other UE, as illustrated and described above with respect to table 3.

In some aspects, the list of eligible UEs and the list of durations may be provided in a same list. In other aspects, the list of durations and the list of eligible UEs may be provided or indicated in separate lists. In some aspects, the lists may be transmitted by the UE 115i in a same SL communication. For example, the lists may be transmitted in a same SCI, RRC message, and/or MAC-CE. In another aspect, the lists may be transmitted in separate SL communications (e.g., separate SCIs, RRC messages, and/or MAC-CEs). In another aspect, actions 610 and 612 may be performed using a single SL transmission. For example, a single PSCCH and PSSCH communication may indicate the COT, COT sharing information, the list of eligible UEs, and/or the list of durations for each eligible UE. In other aspects, the UE 115i may transmit separate SL communications in actions 610 and 612.

At action 613, the UE 115j transmits, based on the list provided at action 612, a PSFCH communication to the UE 115k. In some aspects, action 613 comprises determining or verifying that the UE 115k is on the list provided at action 612. In another aspect, transmitting the PSFCH communication comprises transmitting the PSFCH comprises transmitting the PSFCH based on the list of durations described above. For example, if the distance and/or channel conditions between the UE 115i and the UE 115j satisfies only one of the multi-stage thresholds, the UE 115j may transmit the PSFCH to the UE 115k during a smaller portion 616 of the shared portion 614. In another example, if the distance and/or channel conditions between the UE 115i and the UE 115k satisfies all configured multi-stage thresholds, the UE 115j may transmit the PSFCH in a larger portion of the shared portion 614. In some aspects, longer durations of the shared portion 614 of the COT may increase the chance that a PSFCH may be transmitted. For example, a UE 115 may be configured with a PSFCH period. The period may be configured as a number of slots, for example. Longer durations enabled or allowed for PSFCH transmission during the shared portion may increase the probability that a periodic PSFCH occasion is scheduled within the duration, and therefore may increase the probability that a PSFCH can be transmitted.

In this regard, at action 618, the UE 115j may transmit, to the UE 115m, a PSFCH during the smaller portion 616 of the shared portion 614 of the COT. For example, in some aspects, the UE 115i may determine that the distance and/or channel conditions between the UE 115i and the UE 115m satisfy one or more, but not all, of the configured multi-stage thresholds. The UE 115i may provide the list of durations for the UEs 115j, 115k, and/or 115m based on the multi-stage thresholds. The list may indicate that the UE 115m may transmit in the first N μs of the shared portion 614 of the COT. Accordingly, the UE 115i may transmit the PSFCH in the smaller portion 616, which may include the first N μs of the shared portion 614 of the COT.

Although FIG. 6 illustrates actions 613 and 618 as including PSFCH transmissions, it will be understood that either or both of actions 613 and/or 618 may comprise transmitting other types of SL communications different from PSFCH. For example, either or both of actions 613 and/or 618 may include, instead of or in addition to transmitting PSFCH, transmitting PSCCH, PSSCH, reference signals, and/or any other suitable SL communication during the shared portion 614 of the COT.

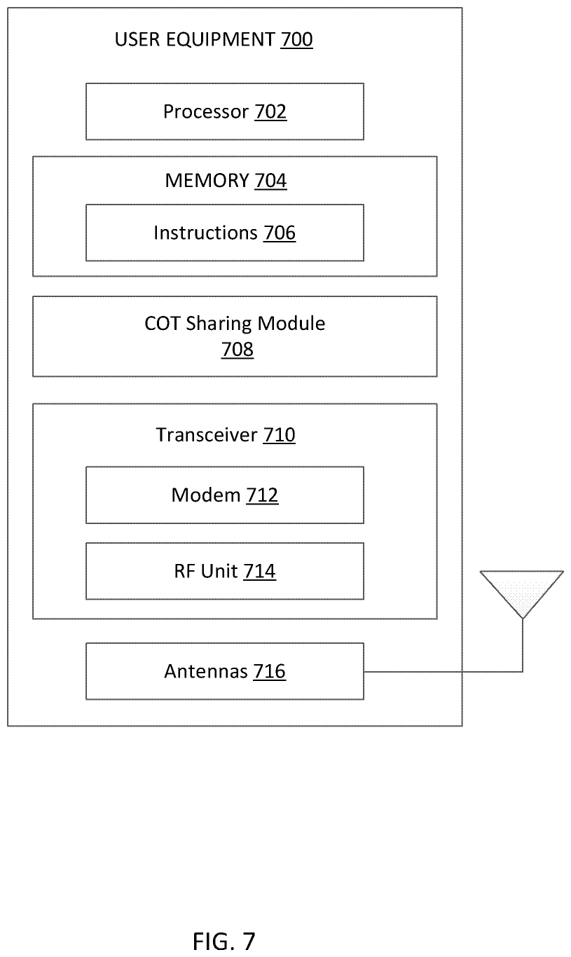

FIG. 7 is a block diagram of an exemplary UE 700 according to some aspects of the present disclosure. The UE 700 may be the UE 115 or a UE 215 in the network 100 or 200 as discussed above. As shown, the UE 700 may include a processor 702, a memory 704, a COT sharing module 708, a transceiver 710 including a modem subsystem 712 and a radio frequency (RF) unit 714, and one or more antennas 716. These elements may be coupled with each other and in direct or indirect communication with each other, for example via one or more buses.

The processor 702 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 702 may also be implemented as a combination of computing devices, e.g., a combination of a DSP and a microprocessor, a plurality of microprocessors, one or more microprocessors in conjunction with a DSP core, or any other such configuration.

The memory 704 may include a cache memory (e.g., a cache memory of the processor 702), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In some instances, the memory 704 includes a non-transitory computer-readable medium. The memory 704 may store instructions 706. The instructions 706 may include instructions that, when executed by the processor 702, cause the processor 702 to perform the operations described herein with reference to the UEs 115 in connection with aspects of the present disclosure, for example, aspects of FIGS. 3-6, 9, and/or 10. Instructions 706 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The COT sharing module 708 may be implemented via hardware, software, or combinations thereof. For example, the COT sharing module 708 may be implemented as a processor, circuit, and/or instructions 706 stored in the memory 704 and executed by the processor 702. In some aspects, In some aspects, the COT sharing module 808 may implement the aspects of FIGS. 3-6, 9, and/or 10. For example, the COT sharing module 708 may performing a listen-before-talk (LBT) procedure. The COT sharing module 708 may acquiring, based on the LBT procedure being successful, a channel occupancy time (COT). The COT sharing module 708 may transmit, to a second sidelink UE during the COT, COT sharing information for sharing the COT with the second sidelink UE. It will be understood that the functions and configuration of the COT sharing module 708 may include controlling and/or cooperating with one or more other components of the UE 700, such as the processor 702, the memory 704, and/or the transceiver 710, to perform the actions described herein. Thus, although the COT sharing module 708 may be described as “configured to” perform an action, it will be understood that the action may be controlled, initiated, and/or monitored by the COT sharing module 708 in conjunction with the one or more other components of the ULE 700.

In some aspects, the COT sharing module 708 may be configured to cause the transceiver 710 to transmit and/or receive an indication of a COT. In some aspects, the COT sharing module 708 is configured to cause the transceiver 710 to communicate a COT sharing indication. In some aspects, the COT sharing indication may include or indicate COT sharing information. The COT indication and/or the COT sharing information may be carried in SCI transmitted in at least one of a PSCCH signal and/or a PSSCH signal. In some aspects, the COT sharing module 708 is configured to cause the transceiver 710 to receive and/or transmit SCI-2 including COT sharing information indicated in a SL_COT_SharingInformation field. In some aspects, the COT sharing information may include time and/or frequency resources associated with a shared portion of a COT.

In some aspects, the COT sharing module 708 is configured to initiate a COT by performing a channel access procedure. For example, the COT sharing module 708 may perform a type 1 channel access procedure to initiate the COT. The type 1 channel access procedure may include a CAT4 LBT. In some aspects, the COT sharing module 708 may be configured to perform a type 2 channel access procedure in order to share a portion of the COT. For example, the COT sharing module 708 may perform a type 2A or type 2B channel access procedure to communicate during a shared portion of the COT.

In some aspects, the COT sharing module 708 is configured to communicate during the shared portion of the COT. For example, the COT sharing module 708 may be configured to communicate SL communications based on a distance between the COT-initiating UE and the receiver of the SL communication. In another aspects, the COT sharing module 708 may be configured to communicate SL communication based on a channel condition between the COT-initiating UE and the receiver of the SL communication. In some aspects, the UE 700 may be the COT-initiating UE. In another aspect, the UE 700 may be the transmitter of the SL communication. In another aspect, the UE 700 may be the receiver of the SL communication. In some aspects, the channel condition may include signal power (e.g., RSRP) and/or pathloss. In another aspect, the channel condition may include reference signal received quality (RSRQ), received signal strength indicator (RSSI), signal to noise ration (SNR), and/or any other suitable channel condition.

In some aspects, the COT sharing module 708 may determine whether to communicate the SL communication based on a comparison of the distance and/or channel condition with a corresponding threshold. In some aspects, the COT sharing module 708 is configured to receive an indication of the threshold in RRC signaling. In another aspect the COT sharing module 708 may receive an indication of the threshold via SCI, a MAC-CE, and/or any other suitable form of communication. In some aspects, the COT sharing module 708 may communicate a list indicating one or more UEs eligible to receive SL communications from a non-COT-initiating UE during a shared portion of the COT. In some aspects, the list may further indicate one or more durations or portions of the shared portion of the COT during which at least one of the one or more UEs may receive the SL communications.

As shown, the transceiver 710 may include the modem subsystem 712 and the RF unit 714. The transceiver 710 can be configured to communicate bi-directionally with other devices, such as the BSs 105 and/or the UEs 115. The modem subsystem 712 may be configured to modulate and/or encode the data from the memory 704 and the according to a modulation and coding scheme (MCS), e.g., a low-density parity check (LDPC) coding scheme, a turbo coding scheme, a convolutional coding scheme, a digital beamforming scheme, etc. The RF unit 714 may be configured to process (e.g., perform analog to digital conversion or digital to analog conversion, etc.) modulated/encoded data from the modem subsystem 712 (on outbound transmissions) or of transmissions originating from another source such as a UE 115 or a BS 105. The RF unit 714 may be further configured to perform analog beamforming in conjunction with the digital beamforming. Although shown as integrated together in transceiver 710, the modem subsystem 712 and the RF unit 714 may be separate devices that are coupled together to enable the UE 700 to communicate with other devices.

The RF unit 714 may provide the modulated and/or processed data, e.g. data packets (or, more generally, data messages that may contain one or more data packets and other information), to the antennas 716 for transmission to one or more other devices. The antennas 716 may further receive data messages transmitted from other devices. The antennas 716 may provide the received data messages for processing and/or demodulation at the transceiver 710. The antennas 716 may include multiple antennas of similar or different designs in order to sustain multiple transmission links. The RF unit 714 may configure the antennas 716.

In some instances, the UE 700 can include multiple transceivers 710 implementing different RATs (e.g., NR and LTE). In some instances, the UE 700 can include a single transceiver 710 implementing multiple RATs (e.g., NR and LTE). In some instances, the transceiver 710 can include various components, where different combinations of components can implement RATs.

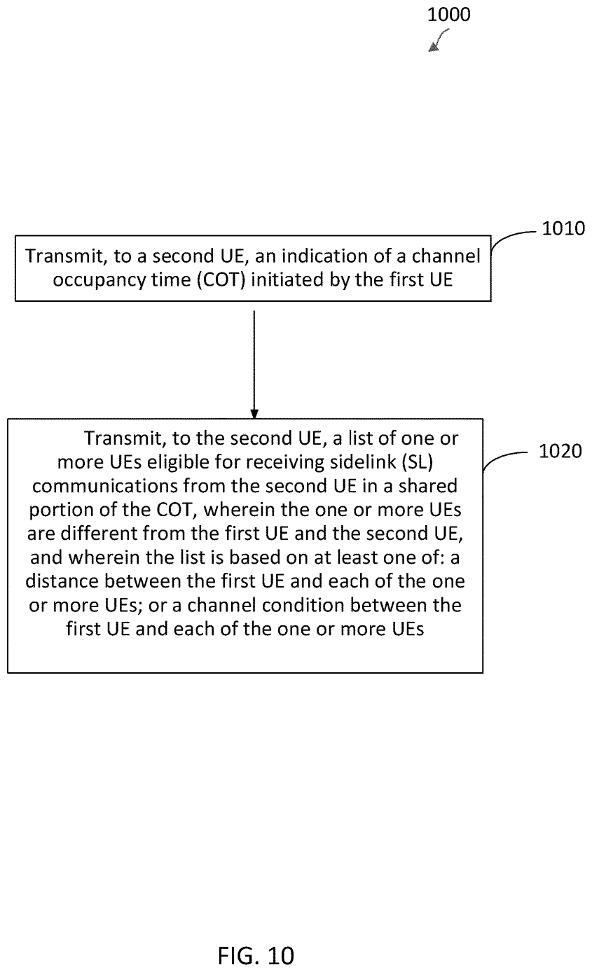

FIG. 10 is a block diagram of an exemplary network unit 800 according to some aspects of the present disclosure. The network unit 800 may be a BS 105, a CU, a DU, or a RU, as discussed above. As shown, the network unit 800 may include a processor 802, a memory 804, a COT sharing module 808, a transceiver 810 including a modem subsystem 812 and a RF unit 814, and one or more antennas 816. These elements may be coupled with each other and in direct or indirect communication with each other, for example via one or more buses.

The processor 802 may have various features as a specific-type processor. For example, these may include a CPU, a DSP, an ASIC, a controller, a FPGA device, another hardware device, a firmware device, or any combination thereof configured to perform the operations described herein. The processor 802 may also be implemented as a combination of computing devices, e.g., a combination of a DSP and a microprocessor, a plurality of microprocessors, one or more microprocessors in conjunction with a DSP core, or any other such configuration.

The memory 804 may include a cache memory (e.g., a cache memory of the processor 802), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some instances, the memory 804 may include a non-transitory computer-readable medium. The memory 804 may store instructions 806. The instructions 806 may include instructions that, when executed by the processor 802, cause the processor 802 to perform operations described herein, for example, aspects of FIGS. 3-6, 9, and/or 10. Instructions 806 may also be referred to as code, which may be interpreted broadly to include any type of computer-readable statement(s).

The COT sharing module 808 may be implemented via hardware, software, or combinations thereof. For example, the COT sharing module 808 may be implemented as a processor, circuit, and/or instructions 806 stored in the memory 804 and executed by the processor 802.

In some aspects, the COT sharing module 808 may implement the aspects of FIGS. 3-6, 9, and/or 10. For example, the COT sharing module 808 may transmit or indicate SL resource pools, COT sharing configurations, distance thresholds, channel condition thresholds, and/or any other feature associated with the aspects of FIGS. 3-6, 9, and 10.

Additionally or alternatively, the COT sharing module 808 can be implemented in any combination of hardware and software, and may, in some implementations, involve, for example, processor 802, memory 804, instructions 806, transceiver 810, and/or modem 812.

As shown, the transceiver 810 may include the modem subsystem 812 and the RF unit 814. The transceiver 810 can be configured to communicate bi-directionally with other devices, such as the UEs 115 and/or 600. The modem subsystem 812 may be configured to modulate and/or encode data according to a MCS, e.g., a LDPC coding scheme, a turbo coding scheme, a convolutional coding scheme, a digital beamforming scheme, etc. The RF unit 814 may be configured to process (e.g., perform analog to digital conversion or digital to analog conversion, etc.) modulated/encoded data from the modem subsystem 812 (on outbound transmissions) or of transmissions originating from another source such as a UE 115 or UE 700. The RF unit 814 may be further configured to perform analog beamforming in conjunction with the digital beamforming. Although shown as integrated together in transceiver 810, the modem subsystem 812 and/or the RF unit 814 may be separate devices that are coupled together at the network unit 800 to enable the network unit 800 to communicate with other devices.

The RF unit 814 may provide the modulated and/or processed data, e.g. data packets (or, more generally, data messages that may contain one or more data packets and other information), to the antennas 816 for transmission to one or more other devices. This may include, for example, a configuration indicating a plurality of sub-slots within a slot according to aspects of the present disclosure. The antennas 816 may further receive data messages transmitted from other devices and provide the received data messages for processing and/or demodulation at the transceiver 810. The antennas 816 may include multiple antennas of similar or different designs in order to sustain multiple transmission links.

In some instances, the network unit 800 can include multiple transceivers 810 implementing different RATs (e.g., NR and LTE). In some instances, the network unit 800 can include a single transceiver 810 implementing multiple RATs (e.g., NR and LTE). In some instances, the transceiver 810 can include various components, where different combinations of components can implement RATs.

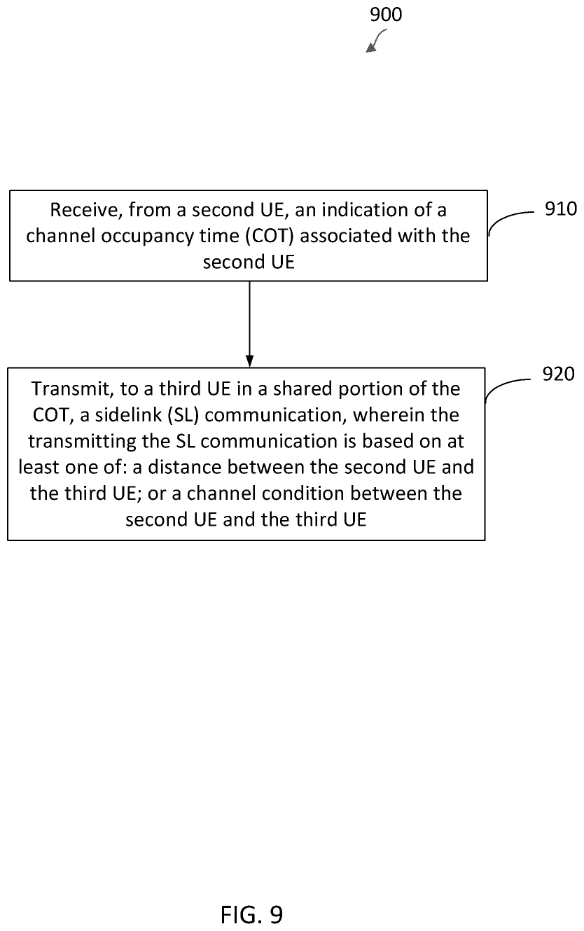

FIG. 9 is a flow diagram of a communication method 900 according to some aspects of the present disclosure. Aspects of the method 900 can be executed by a computing device (e.g., a processor, processing circuit, and/or other suitable component) of a wireless communication device or other suitable means for performing the aspects. For example, a wireless communication device, such as the UE 115, a UE 215, or the UE 700, may utilize one or more components, such as the processor 702, the memory 704, the COT sharing module 708, the transceiver 710, the modem 712, and the one or more antennas 716, to execute aspects of method 900. The method 900 may employ similar mechanisms as in the networks 100 and 200 and the aspects and actions described with respect to FIGS. 3-6. As illustrated, the method 900 includes a number of enumerated aspects, but the method 900 may include additional aspects before, after, and in between the enumerated aspects. In some aspects, one or more of the enumerated aspects may be omitted or performed in a different order.

At action 910, the first UE receives, from the second UE, an indication of a COT associated with the second UE. In some aspects, the COT may be initiated by the second UE. In some aspects, receiving the indication of the COT may comprise receiving at least one of a PSCCH communication and/or a PSSCH communication. For example, the indication may comprise a PSCCH including SCI. The SCI may indicate time and frequency resources for a PSSCH communication. The PSSCH communication may carry or include PSSCH data and/or additional SCI. For example, the PSSCH may comprise SCI-2. In some aspects, the indication of the COT may comprise a COT sharing indication. The COT sharing information may include a COT resource allocation that indicates resources the first UE may use to share the COT. The COT sharing information may include resource allocations to the first UE to share the COT. In some aspects, the first UE may receive the COT sharing information via sidelink control information (e.g., SCI-1, SCI-2), an RRC message, a PSCCH message, a PSSCH message, or other suitable communication. For example, the COT sharing information may be included or indicated in a SL_COT_SharingInformation field via sidelink control information 2 (SCI-2). The first UE may use one or more components, such as the processor 702, the memory 704, the COT sharing module 708, the transceiver 710, the modem 712, and the one or more antennas 716, to execute aspects of action 910.

At action 920, the first UE transmits, to a third UE in a shared portion of the COT, a SL communication. In some aspects, the transmitting is based on at least one of: a distance between the second UE and the third UE; or a channel condition between the second UE and the third UE. As mentioned above, the second UE may be the COT-initiating UE. In some aspects, the first UE may determine whether the third UE is eligible to receive communications during the shared portion of the COT initiated by the second UE based on the distance and/or the channel condition. In one example, determining whether the third UE is eligible comprises determining whether the third UE is on a list of eligible UEs provided by the second UE. As explained above with respect to the method 600, the second UE may generate a list indicating which UEs are eligible to receive communications during the shared portion of the COT. The second UE may generate the list based on the distance between the second UE and third UE, for example, In another aspect, the second UE may generate the list based on a channel condition between the second UE and the third UE. The channel condition may be, for example, RSRP or pathloss.

In some aspects, the transmitting the SL communication comprises transmitting a PSFCH communication to the third UE. The first UE may transmit the PSFCH communication in a PSFCH occasion of a resource pool configured for the first UE. The first UE may transmit the PSFCH communication in response to receiving a PSCCH and/or a PSSCH communication from the third UE. In some aspects, the PSFCH occasion in which the first UE transmits the PSFCH communication may fall within the shared portion of the COT. In other aspects, the transmitting the SL communication may comprise the first UE transmitting at least one of a PSCCH communication, a PSSCH communication, a reference signal, and/or any other suitable type of SL communication. The first UE may use one or more components, such as the processor 702, the memory 704, the COT sharing module 708, the transceiver 710, the modem 712, and the one or more antennas 716, to execute aspects of action 920.

In some aspects, the first UE may perform a channel access procedure before transmitting the SL communication. For example, the first UE may perform a type 2 channel access procedure. In some aspects, the first UE may perform a type 2A or type 2B channel access procedure. In other aspects, the first UE may not perform a channel access procedure. In this regard, the first UE may perform a “type 2C” channel access procedure such that the first UE does not perform channel sensing during the COT before transmitting the SL communication.

In some aspects, the method 900 further comprises the first UE receiving the list of eligible UEs for receiving communications from the second UE.

In some aspects, the COT sharing information may include a time resource allocation associated with the COT sharing. For example, the time resource allocation may include a COT start time, a COT end time, and/or a COT duration. The time resource allocation may include time resources (e.g., slots, sub-slots, symbols, frames, etc.) allocated to the set of sidelink UEs that share the COT. For example, the time resource allocation may indicate index(s) indicating starting slot(s) and/or sub-slot(s) allocated to the set of sidelink UEs. The time resource allocation may indicate a number of time resources (e.g., a number of slots, sub-slots, and/or symbols) allocated to the set of sidelink UEs. The first sidelink UE may indicate the time resource allocation(s) to the sidelink UEs sharing the COT in a time domain resource allocation (TDRA) via SCI-1.

FIG. 10 is a flow diagram of a communication method 1000 according to some aspects of the present disclosure. Aspects of the method 1000 can be executed by a computing device (e.g., a processor, processing circuit, and/or other suitable component) of a wireless communication device or other suitable means for performing the aspects. For example, a wireless communication device, such as the UE 115, or the UE 700, may utilize one or more components, such as the processor 702, the memory 704, the COT sharing module 708, the transceiver 710, the modem 712, and the one or more antennas 716, to execute aspects of method 1000. The method 1000 may employ similar mechanisms as in the networks 100 and 200 and the aspects and actions described with respect to FIGS. 3-6. In some aspects, the method 1000 is performed at least partially based on unlicensed or shared frequency band. For example, the method 1000 may include or involve transmitting one or more SL communications based on a SL-U protocol including channel access procedures, one or more COTs, occupied bandwidth configurations, and/or any other corresponding schemes for communicating in unlicensed bands. As illustrated, the method 1000 includes a number of enumerated aspects, but the method 1000 may include additional aspects before, after, and in between the enumerated aspects. In some aspects, one or more of the enumerated aspects may be omitted or performed in a different order.

At action 1010, the first UE transmits, to the second UE, an indication of a COT associated with the first UE. In some aspects, the COT may be initiated by the first UE. In some aspects, transmitting the indication of the COT may comprise transmitting at least one of a PSCCH communication and/or a PSSCH communication. For example, the indication may comprise a PSCCH including SCI. The SCI may indicate time and frequency resources for a PSSCH communication. The PSSCH communication may carry or include PSSCH data and/or additional SCI. For example, the PSSCH may comprise SCI-2. In some aspects, the indication of the COT may comprise a COT sharing indication. The COT sharing information may include a COT resource allocation that indicates resources the second UE may use to share the COT. The COT sharing information may include resource allocations to the second UE to share the COT. In some aspects, the first UE may transmit the COT sharing information via sidelink control information (e.g., SCI-1, SCI-2), an RRC message, a PSCCH message, a PSSCH message, or other suitable communication. For example, the COT sharing information may be included or indicated in a SL_COT_SharingInformation field via sidelink control information 2 (SCI-2).

At action 1020, the first UE transmits, to the second UE, a list of one or more UEs eligible for receiving SL communications from the second UE in the shared portion of the COT. In some aspects, the one or more UEs are different from the first UE and the second UE. In some aspects, the list includes the second UE and the one or more UEs different form the first UE and the second UE. In some aspects, the list is based on at least one of: a distance between the first UE and the one or more UEs; or a channel condition between the first UE and the one or more UEs. As mentioned above, the first UE may be the COT-initiating UE. In some aspects, the first UE may determine whether the one or more UEs is/are eligible to receive communications during the shared portion of the COT initiated by the first UE based on the distance and/or the channel condition. As explained above with respect to the method 600, the first UE may generate the list based on the distance between the first UE and the one or more UEs. In another aspect, the channel condition may be, for example, RSRP or pathloss.

In some aspect, the method 1000 includes the first UE performing a channel access procedure to initiate the COT. For example, the first UE may perform a type 1 channel access procedure. For example, the first UE may perform a CAT4 LBT. In some aspects, the first UE may determine, generate, and/or update the list of the one or more UEs in response to acquiring the COT. In another aspect, the first UE may determine, generate, and/or update the list in response to receiving SL data and/or SL signaling in a buffer for transmission to the second UE. In some aspects, the first UE may transmit the list in response to acquiring the COT. In some aspects, the first UE may transmit the list in response to receiving the SL data and/or the SL signaling in the buffer.

The first UE may determine or generate the list of eligible UEs according to the schemes described above with respect to FIG. 6. In some aspects, transmitting the list may comprise transmitting SCI indicating the list. For example, the list may be carried or indicated in SCI-1 and/or SCI-2. In another aspect, the list may be transmitting using RRC messaging. In some aspects, the first UE may transmit the list by transmitting a MAC-CE indicating the list of eligible UEs. In another aspect, the method 1000 may further comprise the first UE transmitting a list of COT sharing durations or portions of the shared portion of the COT in which each eligible UE is permitted to receive SL communications from UEs other than the first UE, which initiated the COT.

In one aspect, the list is based on the distance between the first UE and the one or more UEs. The distance may be based on zone ID indications transmitted by the one or more UEs to the first UE, for example. In some aspects, the distance may be based on a comparison of a first zone ID of the first UE and one or more second zone IDs of the one or more UEs. In some aspects, the transmitting the SL communication is based on a comparison of the distance with a distance threshold. In some aspects, the distance threshold may be configured. In some aspects, the comparison may be performed by the second UE. In another aspect, the comparison may be performed by the first UE. In some aspects, the distance threshold may be based on at least one of an energy detection threshold associated with the COT or a quantified interference energy associated with the COT. In this regard, the distance threshold may be determined based on the schemes illustrated with respect to tables 1-3 and the corresponding text.

In another aspect, the list is based on the channel condition between the first UE and the one or more UEs. As explained above, the channel condition may include at least one of a signal power (e.g., RSRP) or a pathloss. However, other types of channel conditions are also contemplated, including signal quality (e.g., RSRQ), received signal strength indicator (RSSI), signal-to-noise (SNR), and/or any other suitable type of channel condition. The list may be based on a comparison of the channel condition between the first UE and the one or more UEs and a configured or indicated channel condition threshold. Similar to the distance threshold, the channel condition threshold may be determined based on the schemes illustrated with respect to tables 1-3 and the corresponding text.

In some aspects, the first UE may transmit the list in response to the first UE initiating the COT. In other aspects, the first UE may periodically or occasionally transmit an updated list of eligible UEs to the second UE and/or to other UEs. In some aspects, the list also indicates one or more durations of the shared portion of the COT in which a UE sharing the COT may transmit to a non-COT-initiating UE. For example, the list may indicate that the third UE may receive during only a portion of the shared portion of the COT (see, e.g., 616, FIG. 6), or during an entirety of the shared portion of the COT (see, e.g., 614, FIG. 6). In another aspect, the first UE may transmit a separate list indicating the durations in addition to or instead of the list of eligible UEs.

Further aspects of the present disclosure include the following:
Aspect 1. A method of wireless communication performed by a first user equipment (UE), the method comprising: receiving, from a second UE, an indication of a channel occupancy time (COT) associated with the second UE; and transmitting, to a third UE in a shared portion of the COT, a sidelink (SL) communication, wherein the transmitting the SL communication is based on at least one of: a distance between the second UE and the third UE; or a channel condition between the second UE and the third UE.
Aspect 2. The method of aspect 1, wherein the transmitting the SL communication is based on the distance between the second UE and the third UE, and wherein the transmitting the SL communication is further based on a comparison of the distance with a distance threshold.
Aspect 3. The method of aspect 2, wherein the distance threshold is based on at least one of an energy detection threshold associated with the COT or a quantified interference energy associated with the COT.
Aspect 4. The method of any of aspects 1-3, wherein the transmitting the SL communication is based on the channel condition between the second UE and the third UE, wherein the channel condition comprises a signal power, and wherein the transmitting the SL communication is further based on a comparison of the signal power with a signal power threshold.
Aspect 5. The method of aspect 4, wherein the signal power threshold is based on at least one of an energy detection threshold associated with the COT or a quantified interference energy associated with the COT.
Aspect 6. The method of any of aspects 1-5, wherein the transmitting the SL communication is based on the channel condition between the second UE and the third UE, wherein the channel condition comprises a pathloss, and wherein the transmitting the SL communication is further based on a comparison of the pathloss with a pathloss threshold.
Aspect 7. The method of aspect 6, wherein the pathloss threshold is based on at least one of an energy detection threshold associated with the COT or a quantified interference energy associated with the COT.
Aspect 8. The method of any of aspects 1-7, further comprising: receiving, from the second UE, a list of one or more UEs eligible for receiving SL communications from the first UE in a shared portion of the COT, wherein the one or more UEs are different from the first UE and the second UE, wherein the one or more UEs comprise the third UE, and wherein the list is based on at least one of: a distance between the second UE and the each of the one or more UEs; or a channel condition between the second UE and each of the one or more UEs.
Aspect 9. The method of aspect 8, further comprising: receiving, from the second UE, an indication of one or more durations of the shared portion of the COT corresponding to the one or more UEs, wherein each of the one or more durations is based on a comparison of at least one threshold with at least one of: the distance between the second UE and the one or more UEs; or the channel condition between the second UE and the one or more UEs.
Aspect 10. The method of aspect 9, wherein the at least one threshold is based on at least one of a configured energy detection threshold associated with the COT or a quantified interference energy associated with the COT.
Aspect 11. A method of wireless communication performed by a first user equipment (UE), the method comprising: transmitting, to a second UE, an indication of a channel occupancy time (COT) initiated by the first UE; and transmitting, to the second UE, a list of one or more UEs eligible for receiving sidelink (SL) communications from the second UE in a shared portion of the COT, wherein the one or more UEs are different from the first UE and the second UE, and wherein the list is based on at least one of: a distance between the first UE and each of the one or more UEs; or a channel condition between the first UE and each of the one or more UEs.
Aspect 12. The method of aspect 11, further comprising: transmitting, to the second UE, an indication of one or more durations of the shared portion of the COT corresponding to the one or more UEs, wherein each of the one or more durations is based on a comparison of at least one threshold with at least one of the distance between the second UE and each of the one or more UEs; or the channel condition between the second UE and each of the one or more UEs.
Aspect 13. The method of aspect 12, wherein the at least one threshold is based on at least one of an energy detection threshold associated with the COT or a quantified interference energy associated with the COT.
Aspect 14. The method of any of aspects 11-13, wherein the list is based on the distance between the first UE and each of the one or more UEs, and wherein the list is further based on a comparison of the distance between the first UE and each of the one or more UEs with a distance threshold.
Aspect 15. The method of aspect 14, wherein the distance threshold is based on at least one of an energy detection threshold associated with the COT or a quantified interference energy associated with the COT.
Aspect 16. The method of any of aspects 11-15, wherein the list is based on the channel condition between the first UE and each of the one or more UEs, wherein the channel condition comprises a signal power, and wherein the list is further based on a comparison of the signal power between the first UE and each of the one or more UEs with a signal power threshold.
Aspect 17. The method of aspect 16, wherein the signal power threshold is based on at least one of an energy detection threshold associated with the COT or a quantified interference energy associated with the COT.
Aspect 18. The method of any of aspects 11-17, wherein the list is based on the channel condition between the first UE and each of the one or more UEs, wherein the channel condition comprises a pathloss, and wherein the list is further based on a comparison of the pathloss between the first UE and each of the one or more UEs with a pathloss threshold.
Aspect 19. The method of aspect 18, wherein the pathloss threshold is based on at least one of an energy detection threshold associated with the COT or a quantified interference energy associated with the COT.
Aspect 20. A first UE comprising: a memory device; a transceiver; and a processor in communication with the memory device and the transceiver, wherein the first UE is configured to perform the actions of any of aspects 1-10.
Aspect 21. A first UE comprising: a memory device; a transceiver; and a processor in communication with the memory device and the transceiver, wherein the first UE is configured to perform the actions of any of aspects 11-19.
Aspect 22. A non-transitory, computer-readable medium having program code recorded thereon, wherein the program code comprises instructions executable by a processor of a UE to cause the UE to perform the actions of any of aspects 1-10.
Aspect 23. A non-transitory, computer-readable medium having program code recorded thereon, wherein the program code comprises instructions executable by a processor of a UE to cause the UE to perform the actions of any of aspects 11-19.
Aspect 24. A UE comprising means for performing the actions of any of aspects 1-10.
Aspect 25. A UE comprising means for performing the actions of any of aspects 11-19.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular instances illustrated and described herein, as they are merely by way of some examples thereof, but rather, should be fully commensurate with that of the claims appended hereafter and their functional equivalents.

1. A method of wireless communication performed by a first user equipment (UE), the method comprising:
receiving, from a second UE, an indication of a channel occupancy time (COT) associated with the second UE; and
transmitting, to a third UE in a shared portion of the COT, a sidelink (SL) communication, wherein the transmitting the SL communication is based on at least one of:
a distance between the second UE and the third UE; or
a channel condition between the second UE and the third UE.

2. The method of claim 1, wherein the transmitting the SL communication is based on the distance between the second UE and the third UE, and wherein the transmitting the SL communication is further based on a comparison of the distance with a distance threshold.

3. The method of claim 2, wherein the distance threshold is based on at least one of an energy detection threshold associated with the COT or a quantified interference energy associated with the COT.

4. The method of claim 1, wherein the transmitting the SL communication is based on the channel condition between the second UE and the third UE, wherein the channel condition comprises a signal power, and wherein the transmitting the SL communication is further based on a comparison of the signal power with a signal power threshold.

5. The method of claim 4, wherein the signal power threshold is based on at least one of an energy detection threshold associated with the COT or a quantified interference energy associated with the COT.

6. The method of claim 1, wherein the transmitting the SL communication is based on the channel condition between the second UE and the third UE, wherein the channel condition comprises a pathloss, and wherein the transmitting the SL communication is further based on a comparison of the pathloss with a pathloss threshold.

7. The method of claim 6, wherein the pathloss threshold is based on at least one of an energy detection threshold associated with the COT or a quantified interference energy associated with the COT.

8. The method of claim 1, further comprising:
receiving, from the second UE, a list of one or more UEs eligible for receiving SL communications from the first UE in a shared portion of the COT, wherein the one or more UEs are different from the first UE and the second UE, wherein the one or more UEs comprise the third UE, and wherein the list is based on at least one of:
a distance between the second UE and the each of the one or more UEs; or
a channel condition between the second UE and each of the one or more UEs.

9. The method of claim 8, further comprising:
receiving, from the second UE, an indication of one or more durations of the shared portion of the COT corresponding to the one or more UEs, wherein each of the one or more durations is based on a comparison of at least one threshold with at least one of:
the distance between the second UE and the one or more UEs; or
the channel condition between the second UE and the one or more UEs.

10. The method of claim 9, wherein the at least one threshold is based on at least one of a configured energy detection threshold associated with the COT or a quantified interference energy associated with the COT.

11. A method of wireless communication performed by a first user equipment (UE), the method comprising:
transmitting, to a second UE, an indication of a channel occupancy time (COT) initiated by the first UE; and
transmitting, to the second UE, a list of one or more UEs eligible for receiving sidelink (SL) communications from the second UE in a shared portion of the COT, wherein the one or more UEs are different from the first UE and the second UE, and wherein the list is based on at least one of:
a distance between the first UE and each of the one or more UEs; or
a channel condition between the first UE and each of the one or more UEs.

12. The method of claim 11, further comprising:
transmitting, to the second UE, an indication of one or more durations of the shared portion of the COT corresponding to the one or more UEs, wherein each of the one or more durations is based on a comparison of at least one threshold with at least one of:
the distance between the second UE and each of the one or more UEs; or
the channel condition between the second UE and each of the one or more UEs.

13. The method of claim 12, wherein the at least one threshold is based on at least one of an energy detection threshold associated with the COT or a quantified interference energy associated with the COT.

14. The method of claim 11, wherein the list is based on the distance between the first UE and each of the one or more UEs, and wherein the list is further based on a comparison of the distance between the first UE and each of the one or more UEs with a distance threshold.

15. The method of claim 14, wherein the distance threshold is based on at least one of an energy detection threshold associated with the COT or a quantified interference energy associated with the COT.

16. The method of claim 11, wherein the list is based on the channel condition between the first UE and each of the one or more UEs, wherein the channel condition comprises a signal power, and wherein the list is further based on a comparison of the signal power between the first UE and each of the one or more UEs with a signal power threshold.

17. The method of claim 16, wherein the signal power threshold is based on at least one of an energy detection threshold associated with the COT or a quantified interference energy associated with the COT.

18. The method of claim 11, wherein the list is based on the channel condition between the first UE and each of the one or more UEs, wherein the channel condition comprises a pathloss, and wherein the list is further based on a comparison of the pathloss between the first UE and each of the one or more UEs with a pathloss threshold.

19. The method of claim 18, wherein the pathloss threshold is based on at least one of an energy detection threshold associated with the COT or a quantified interference energy associated with the COT.

20. A first user equipment (UE), comprising:
a memory device;
a transceiver; and
a processor in communication with the memory device and the transceiver, wherein the UE is configured to:
receive, from a second UE, an indication of a channel occupancy time (COT) associated with the second UE; and
transmit, to a third UE in a shared portion of the COT, a sidelink (SL) communication, wherein the transmitting the SL communication is based on at least one of:
a distance between the second UE and the third UE; or
a channel condition between the second UE and the third UE.

21-30. (canceled)
